(19) United States
(12) Patent Application Publication
(10) Pub. No.: US 2024/0249371 A1
(43) Pub. Date: Jul. 25, 2024

(54) SYSTEM, METHOD, AND COMPUTER-PROGRAM PRODUCT FOR TASK-BASED SHORT-TERM MANAGEMENT OF A MINE SITE

(71) Applicant: Caterpillar Inc., Peoria, IL (US)

(72) Inventors: Russell BROCKHURST, Carindale (AU); Carla WESLEY, Queensland (AU); Thomas F. DOHERTY, Queensland (AU); John HARPOUR, Queensland (AU); Daniel P. ADCOCK, Queensland (AU); Adam Marshall LEWIS, Queensland (AU); Alexander BALL, Queensland (AU)

(73) Assignee: Caterpillar Inc., Peoria, IL (US)

(21) Appl. No.: 18/098,748

(22) Filed: Jan. 19, 2023

(51) Int. Cl. G06Q 50/02; G06Q 10/0631

(52) U.S. Cl. CPC G06Q 50/02; G06Q 10/06312; G06Q 10/06316

(57) ABSTRACT

Systems, methods, and computer-program products can perform task-based management of a mine site. The systems, methods, and computer-program products can create, from and for immutable jobs of an imported plan, ranked tasks to be performed at the mine site; and assign tasks falling within a defined window of time to be performed by work machines at the mine site. The assignment of the tasks can be output on a specialized operator interface. Generally, the tasks can be assigned such that as many tasks as possible are scheduled to be completed by a predetermined time.

### TECHNICAL FIELD

The present disclosure pertains to systems, methods, and computer-program products for planning and/or management of a mine site, particularly dynamic task-based, short-term planning and/or management of a mine site.

### BACKGROUND

Beyond artisanal and small-scale mining, planning can be an essential practice throughout the mining industry. Life of Mine Plans (LOMP) can be used to justify capital investments, maximize the economic potential of ore bodies, protect the environment, and facilitate progressive reclamation. Multi-year plans may be broken down into annual plans, monthly plans, daily plans, shift plans, and even hourly plans. While short-term plans should be aligned to longer term plans, short-term plans may also be influenced by commodity prices and delivery schedules.

Australian Patent Document AU 2012101082 A4 (“the AU '082 patent document”) describes a mine scheduling system and method that involves integrating the operations of a plurality of mine sites and associated infrastructure distributed across at least one regional area and producing one or more bulk commodities. According to the AU '082 patent document, the system and method comprise scheduling infrastructure and associated mining activities at each of the mine sites to produce a scheduled level of ore at each mine site and transmitting operational data from equipment at each of the mine sites to an operations facility common to the mine sites and associated infrastructure. The AU '082 patent document further describes selecting a sub-set of the operational data from each mine site and associated infrastructure and displaying information indicative of the sub-sets at the operations facility to identify a production rate from one or more of the mine sites and associated infrastructure below the scheduled level of production, and rescheduling the mining activities at one or more of the mine sites and/or associated infrastructure in response to identifying a production rate at a mine site or associated infrastructure below a scheduled rate so as to minimize any reduction to aggregate output from the mine sites. However, the AU '082 patent document is not understood to describe task-based planning and/or management, let alone task-based planning and/or management in the context of short interval control (SIC).

### SUMMARY

According to one or more embodiments of the disclosed subject matter, systems, methods, and computer-program products can perform task-based management of a mine site. The systems, methods, and computer-program products can create, from and for immutable jobs of an imported plan, ranked tasks to be performed at the mine site; and assign tasks falling within a defined window of time to be performed by work machines at the mine site. The assignment of the tasks can be output on a specialized operator interface. Generally, the tasks can be assigned such that as many tasks as possible are scheduled to be completed by a predetermined time.

According to one or more embodiments of the disclosed subject matter, a method of managing a mine site is disclose or can be implemented. The method, which can be computer-implemented, can comprise: electronically importing a short-term plan as a set of one or more immutable jobs into memory of a processor; electronically creating, using the processor, ranked tasks from and for the one or more immutable jobs to be performed by work machines at the mine site; selectively transitioning, using the processor, at least some of the tasks from a first state to a second state; electronically identifying, using the processor, a short interval control (SIC) window associated with the short-term plan, the SIC window being shorter in time than the short-term plan; determining which of the tasks are in the second state and overlap the SIC window in time; automatically electronically assigning the work machines to the tasks determined to be in the second state and overlapping the SIC window; and electronically outputting, on a specialized operator graphical user interface, the assignments of the work machines to the tasks overlapping the SIC window. A production rate of one or more of the work machines is set to vary over the SIC window when performing the one or more tasks.

According to one or more embodiments of the disclosed subject matter, an assignment engine system to perform managing operations according to task-based short-term planning can be provided or implemented. The assignment engine system can comprise: planning circuitry configured to electronically provide a short-term plan for a mine site to be managed, the short-term plan defining at least an amount of material to be moved at the mine site; and processing circuitry operative as a fleet management system (FMS) and configured to electronically import, from the planning circuitry, the short-term plan as a set of immutable jobs into memory of the processing circuitry, electronically receive data associated with the mine site, the data including mine site-related data and machine-related data regarding a plurality of haul trucks and one or more loaders for the mine site, electronically automatically create ranked tasks from and for the immutable jobs to be performed by at least the haul trucks based on the mine-site related data and the machine-related data, selectively transition, using a specialized operator graphical user interface in coordination with the processing circuitry, the tasks from a ‘Ready’ state to an ‘Available’ state, electronically identify a short interval control (SIC) window associated with the short-term plan, the SIC window being shorter in time than the short-term plan, determine which of the tasks in the ‘Available’ state overlap the SIC window in time, electronically select, from among all of the tasks in the ‘Available’ state, only the tasks in the ‘Available’ state that overlap the SIC window in time, automatically electronically assign the haul trucks to the selected tasks over the SIC window based on the task ranking and such that as many of the selected tasks are to be finished as possible in order of the task ranking within a predefined time period, and electronically output, on the specialized operator graphical user interface, indicia showing the assignment of the haul trucks to the selected tasks over the SIC window.

And according to one or more embodiments of the disclosed subject matter, a non-transitory computer-readable storage medium having stored thereon instructions that, when executed by one or more processors, causes the one or more processors to perform a method can be provided or implemented. The method can comprise: automatically creating, from and for immutable jobs of an imported short-term plan, ranked production tasks to be performed by a plurality of haul trucks at a mine site; identifying a short interval control (SIC) window associated with the short-term plan, the SIC window being shorter in time than the short-term plan; determining which of the production tasks identified as being in a predefined state, from among multiple predefined states, overlap the SIC window in time; selecting, from among all of the production tasks in the predefined state, only the production tasks that overlap the SIC window; automatically assigning each of the selected production tasks to the haul trucks based on task ranking and taking into account each of the other selected production tasks within the SIC window; and outputting, on a specialized operator graphical user interface, interactive visual representations of the assignments of the haul trucks to the production tasks.

### BRIEF DESCRIPTION OF DRAWINGS

FIG. 1 illustrates an exemplary mine site in which embodiments of the present disclosure may be realized.

FIG. 2 is a schematic illustration of a mining management system according to one or more embodiments of the present disclosure. Additionally or alternatively, the mining management system may be referred to or characterized as a mining planning system, according to one or more embodiments of the present disclosure.

FIGS. 3A-3C show a specific example of a specialized analyzing operator interface (spanning the three sheets) according to one or more embodiments of the present disclosure.

FIGS. 4A-4C show another portion of the specific example of the specialized analyzing operator interface (spanning the three sheets) of FIGS. 3A-3C.

FIGS. 5A-5E show a specific example of a specialized management operator interface (annotated) (spanning the five sheets) according to one or more embodiments of the present disclosure.

FIG. 6A shows a specific example of a specialized short interval control (SIC) operator interface according to one or more embodiments of the present disclosure.

FIG. 6B shows annotations to a portion of a specialized short interval control (SIC) based on that of FIG. 6A.

FIGS. 7A-7D show a specific example of a specialized active work operator interface (annotated) (spanning the four sheets) according to one or more embodiments of the present disclosure.

FIGS. 8A-8D show various scenarios for the specialized short interval control (SIC) operator interface according to one or more embodiments of the present disclosure.

FIG. 9 is a diagram of a flow of operations according to embodiments of the present disclosure.

FIG. 10 is a flow chart of a method according to one or more embodiments of the present disclosure.

FIG. 11 is a flow chart of a method according to one or more embodiments of the present disclosure.

FIG. 12 is a flow chart of a method according to one or more embodiments of the present disclosure.

FIG. 13 is a flow chart of a method according to one or more embodiments of the present disclosure.

### DETAILED DESCRIPTION

The present disclosure pertains to systems, methods, and computer-program products for planning and/or management of a mine site, particularly dynamic task-based, short-term planning and/or management of a mine site.

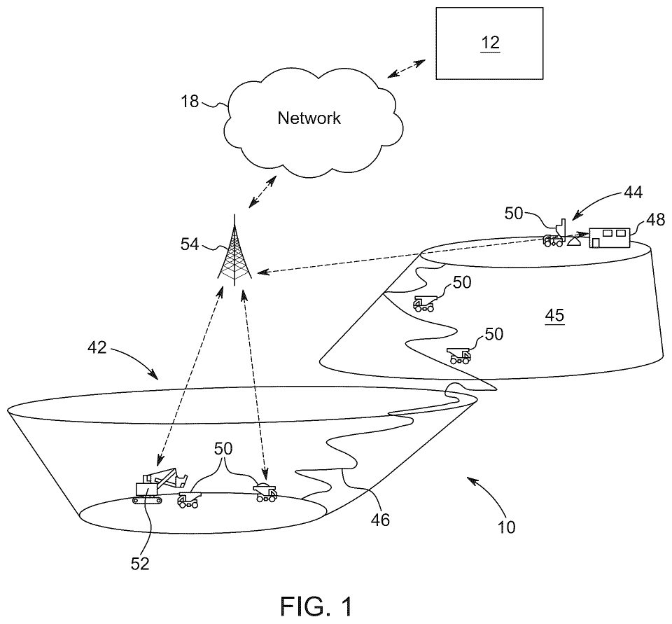

FIG. 1 illustrates an example of a mine site 10 in which embodiments of the present disclosure may be realized. The mine site 10 of FIG. 1 is depicted an open-pit mine, however, embodiments of the present disclosure are not limited in its application to open pit mining operations but can also extend to underground mining practices such as, but not limited to, stope mining, or other types of mining processes commonly known to persons skilled in the art. The mine site 10 in the form of an open pit mine operation can include a pit 42 and a processing region 44 which may be, but is not required to be, at an elevation different from that of the pit 42 for e.g., on top of a dumping mound 45 as shown exemplarily in the view of FIG. 1. A processing plant 48 may be included at the processing region 44. The processing plant 48 may include one or more processing machines e.g., one or more crushers, amongst other types of machines known to one skilled in the art. For purposes of simplicity, each of these machines may hereinafter be referred to as a ‘processor,’ not to be confused with one or more processors (e.g., processing circuitry) of a controller 20 of a mining management system 12 according to aspects of the present disclosure. The mining management system 12 may be regarded as a management engine system to perform managing operations for the mine site 10.

The pit 42 may be connected to the processing region 44 by at least one haul road 46. Each haul road 46 may be one of a number of haul roads 46. One or more hauling machines 50 (e.g., a fleet of hauling machines 50) may travel from the area of excavation of the pit 42 along the haul road 46(s) to the processing plant 48. As examples, each of the hauling machines 50 may be an articulated truck, an off-highway truck, an on-highway dump truck, a wheel tractor-scraper. The fleet of hauling machines 50 may include one or more of each of the foregoing examples, or a combination of two or more of the foregoing examples.

In the pit 42, one or more digging machines 52 e.g., an excavator, a backhoe, a dozer, a drilling machine, a trencher, a drag line may operate to excavate material, which may be ore, overburden, or any other type of material associated with the mining operation. The excavated material may be suitably loaded into the hauling machine 50 by a loading machine e.g., a wheeled or tracked loader, a front shovel, an excavator, a cable shovel, a stack reclaimer, or any other similar machine. Optionally, the digging machine 52 may be embodied to perform functions of both the digging machine as well as the loading machine. Accordingly, the hauling machine 50 may carry a payload when traveling from the pit 42 to the processing plant 48.

In an aspect of the present disclosure, the mine site 10 may include a conveyor system e.g., an in-pit crushing and conveyance (IPCC) system to facilitate material transport between an excavation location, such as the pit 42, and a processing location, such as the processing region 44 and/or between a processing location, such as the processing region 44, and a location at which the material is prepared for transport to an offsite location. In another aspect of the present disclosure, the mine site 10 may include a waste dump at which waste material, such as overburden, may be deposited.

Each of the machines i.e., hauling and digging machines 50, 52 and/or the processing plant 48 at the mine site 10 may be in communication with each other and with a central station 54 by way of wireless communication to remotely transmit and receive operational data and instructions or commands. The central station 54 may be at the mine site 10 or proximate the mine site 10. Additionally, or optionally, the processing plant 48 may be in communication with the central station 54 by way of a wireless network 18. The central station 54 may, in turn, be connected to the mining management system 12 via the network 18 in order to provide mine site data to the mining management system 12, which may be used to perform mining operation planning and/or management for the mine site 10. As an example, the mine site data may pertain to the pit 42 alone. The mining management system 12 may be located at the mine site 10 or may be located at another location remote from the mine site 10.

The machines (e.g., the hauling machine 50, the digging machine 52, and/or the loading machine), the processing plant 48, and/or other elements e.g., personnel operating at the mine site 10 may each include one or more sensors coupled with a controller that records and transmits data to the mining management system 12, via the central station 54 and/or the network 18. As an example, sensors of respective machines 50, 52 may gather data relating to machine position, machine speed, machine power source, transmission, traction device, work implement, operator station, or other component and subsystems of the respective machines 50, 52.

A cycle, in the context of the present disclosure, can be regarded as a collection of activities involved in moving a single unit of material from one location to another. For example, for one of the hauling machines 50, a cycle can extend from a travelling empty state or phase, to a loading state or phase (e.g., in the pit 42 by the digging machine 52), to a travelling loaded state or phase (e.g., via one or more haul roads 46), and to a dumping state or phase (e.g., at processing region 44). As another example, for a loading tool (e.g., digging machine 52), a cycle, in the context of the present disclosure, can be regarded as including a sequence of digs and dippers states or phases (i.e., tipping material into the hauling machine 50) involved in loading a single hauling machine 50. For a loading tool (e.g., the digging machine 52) working in a load-haul-dump (LHD) mode, a cycle, in the context of the present disclosure, can be regarded as including a travelling empty state or phase, a digging state or phase, a travelling loaded (e.g., full) state or phase, and a dumping state or phase.

Cycles may be used to record historical and current production (i.e., up to the present moment) at the mine site 10. In embodiments of the present disclosure, current and/or historical cycles may be matched to tasks to determine progress towards task completion and current and historical production rates, respectively. According to one or more embodiments, cycles can be created as soon as one of the hauling machines 50 starts to travel empty. Initially, the cycle may contain very little data other than the start time. Over time, additional data can be added to the cycle. For example, the material and mining block loaded can be added when one of the hauling machines 50 is loaded based on the material and mining block reported by the associated loading tool (e.g., the digging machine 52). The cycle may not be considered “historical” until the hauling machines 50 tips its load at a dump and starts to travel empty again (i.e., starts a new cycle). While most reporting can be performed off of completed (historical cycles), some reporting may include information from active cycles. The most common situation for this would be a machine that has been on a maintenance delay for an extended period. A machine on a maintenance delay could have an active cycle that is a day, a week, or a month or more in length. Information from such cycles may be used to report that these machines have been unavailable for production during part or all of the reporting period.

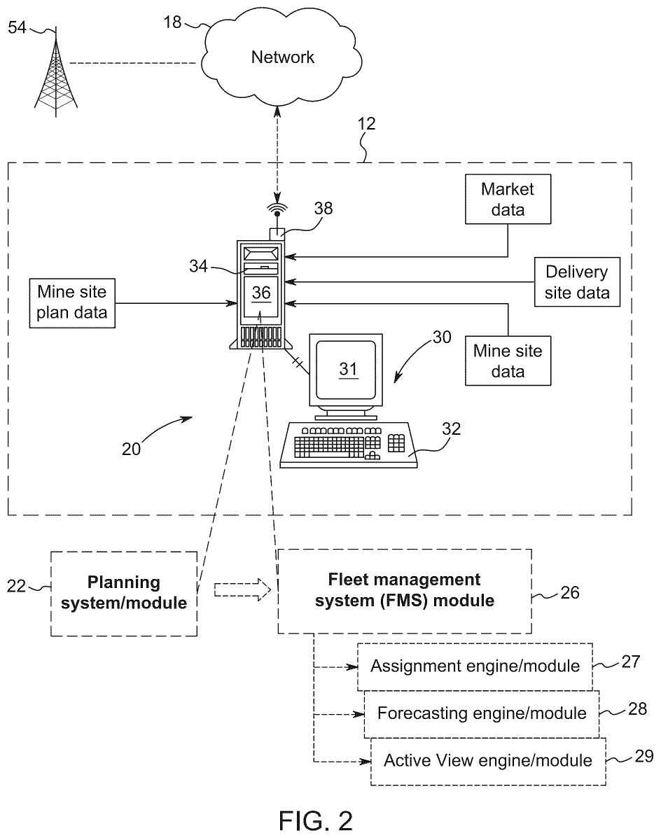

FIG. 2 is a schematic illustration of the mining management system 12. The mining management system 12 may receive data, for the planning and/or management of the mine site 10, including mine site-related data and mine site planning data (i.e., one or more plans each with one or more jobs for the mine site 10). Optionally, mining management system 12 can receive other types of information that may be helpful or useful for mine site planning and/or management, such, but not limited to, as market data, weather data, delivery site data, and feed rate of crusher.

The mine-site related data can include machine data, such as number and type of machines at or available for the mine site 10, machine status, telemetry data, and other types of machine pertinent data that are consistent with functions performed herein. Such machine data may be received continuously in real time and/or according to batch processing. The mine-site related data can also include mining block, or material related, information (e.g., material type, quantity, composition and/or constitution), for instance, from a geological survey carried out either beforehand or in real-time through suitable sensory functions on the machines themselves.

In the case of mine site planning data, the mining management system 12 can receive a mine plan once a day or once a shift, for instance, updated to adapt to changes at the mine site 10. The mine plan may be for a set duration and may include, involve or require, among other processes, allocation of operators to machines, scheduling breaks, moving loading tools to specific types of machines (e.g., digging machine 52), opening or closing dumps at specific locations on the mine site 10, allocating hauling machines 50 to loading tools, and adding production and/or material related restrictions such as, but not limited to, material blend requirements as will be discussed in more detail below. For purposes of this disclosure, the mine plan may therefore be regarded as the short-term plan.

The mining management system 12 can receive the data from the mine site 10, from the machines 50, 52, and/or from the processing plant 48, among other sources, directly and/or via the central station 54, and process the data for planning and/or management of the mine site 10. The data may be received continuously in real-time and/or according to batch processing.

The mining management system 12 may include a controller 20 in communication with various components at the mine site 10 via the network 18 and configured to process the data from a variety of sources, such as those discussed above, and to develop and implement planning and/or management processes or methodologies within the mining operation. As noted above, the mining management system 12 (including the controller 20 thereof) may be located proximate to the mine site 10 or may be located at a considerable distance remote from one of the mine site 10, such as in a different city or even a different country. It is also contemplated that computers at different locations may be networked together to form the controller 20, if desired. In one aspect, the controller 20, or portions thereof, may be located onboard a machine e.g., the hauling machine 50, the digging machine 52, and/or the loading machine that is onsite at the mine site 10. The controller 20 may include any type of general, or special, purpose computer or a plurality of general and/or special purpose computers networked together.

The controller 20 may include among other components, a console 30, an input device or devices 32, an input/output device or devices 34, storage media 36, and one or more communication interfaces 38. The console 30 may be configured to include any appropriate type of display device that can provide an operator control interface 31, for instance, a graphical user interface (GUI), to display results and information to operators of the mining management system 12. The operator control interface 31 can also receive inputs, control and/or data, for planning and/or management of the mine site 10.

The input device 32 may facilitate operator input of input information into the controller 20. The input device 32 may include, for example, a keyboard, a mouse, and/or another type of input device that is commonly known in the art. In some aspects the operator control interface 31 may be considered part of the input device 32.

The input/output device 34 may be any type of device configured to read/write information from/to a portable recording medium. The input/output device 34 may include among other things, a floppy disk, a CD, a DVD, a flash memory read/write device, RAM, hard disk, or the like. The input/output device 34 may be provided to transfer data into and out of the controller 20 using a portable recording medium.

The storage media 36 may include any suitable computer-readable memory to store data within the controller 20, such as a hard disk. The storage media 36 may be used to store a database containing data such as a mine plan or plans, mine site data (e.g., received in real time and/or historical), machine-related data (e.g., received in real time and/or historical), and operator-related data. The storage media 36 may also store computer-readable instructions for the controller 20 to perform mine site planning and/or mine site management operations or methods according to embodiments of the present disclosure, responsive to the computer-readable instructions being executed by one or more processors of the controller 20. According to one or more embodiments, the storage media 36 may be referred to or characterized in whole or in part as non-transitory computer-readable storage media (or a medium).

The communication interface 38 may provide connections with the network 18, enabling the controller 20 to be remotely accessed through computer networks and for data to be transferred into and out of the controller 20. The communication interface 38 may contain network connections, data link connections, and/or antennas configured to receive wireless data.

Data from or for the mine site 10, such as the data discussed earlier, may be transferred to the controller 20 via electronic transfer, which may include remote transfer of the data using the wireless capabilities or the data link of the communication interface 38 by a communication channel or channels. Data may also be electronically transferred into the controller 20 through a portable recording medium e.g., USB, Flash drives, Solid state drives, compact disks, floppies, but not limited thereto, using the input/output device 34. The input device 32 and the operator control interface 31 may also be used to provide data to the controller 20, as mentioned above.

Regarding planning and management of the mine site 10, the controller 20 can be operative as a Fleet Management System (FMS) or module 26. According to one or more embodiments, the controller 20 can be operative as a planning system or module 22, as shown in FIG. 2. Alternatively, the planning system 22 can be offboard the controller 20 or offboard the mining management system 12. Optionally, the FMS 26 or the planning system 22 may implement some operations of a short interval control (SIC) system, such as collecting information from different sources to support determinations. Short interval control (SIC) may also be referred to herein as short-term interval control (SIC).

Short-term plans can be electronically communicated to the planning system 22 of the mining management system 12, and can be implemented, for instance, by coordinating work machine (e.g., digging machine 52 and haul hauling machine(s) 50) operations and configuring the Fleet Management System (FMS) 26 for planning and management (e.g., enhanced, optimal, automated) of the execution of load, haul, and dump activities. Implementing the short-term plan may involve allocating operators to machines, scheduling breaks, moving loading tools, opening or closing dumps, allocating hauling machine(s) 50 to one or more loading tools (e.g., digging machine 52), and adding production restrictions such as blend requirements, as examples. The controller 20, according to one or more embodiments of the present disclosure, may store metrics for jobs and tasks regarding on-time (or not) completion for further analysis. The compliance metrics may be fed back to the planning system 22 to improve the next iteration of the short-term plan.

Discussed in more detail below, the Fleet Management System (FMS) 26 can include or be operative as an assignment engine or module 27, a forecasting engine or module 28, and/or an active work engine or module 29. The assignment engine 27 and the forecasting engine 28 may be referred to herein as an Assignment and a Forecaster, respectively. Further, two or more of the assignment engine 27, the forecasting engine 28, and the active work engine 29 may operate at the same time or in parallel (e.g., in the background while another is operating). According to one or more embodiments, caches or tables of tasks, production arcs, and forecast rates, as defined herein, may constitute an integration point between the assignment engine 27 and each of the forecasting engine 28 and the active work engine 29 or associated aspects thereof, such as a specialized short interval control (SIC) operator interface and a specialized active work operator interface, respectively, as will be discussed in more detail below. Each of the assignment engine 27, the forecasting engine 28, and the active work engine 29 may be implemented in or using one or more processors or processing circuitry.

A short-term plan can be regarded as an electronic document that instructs the mining operations team on the outcomes (or jobs) required. There may be no specific constraints on the contents of an “outcome.” Examples of outcomes in the mining industry can include production target, operational delays, non-production work, and/or drill and blast; the foregoing exemplary outcomes, however, are not meant to be a complete list of mining outcomes. A short-term plan, in the context of the present disclosure, can mean or be characterized as a three-month or less plan. An operational plan (e.g., a 12-24 hour plan), in the context of the present disclosure, can be regarded as a portion or a sub-set of a short-term plan as defined by a site planning department, which can instruct the mining operations team on the outcomes required for the next period (e.g., twelve- to twenty-four-hour period). This plan can be intended for execution by the day and/or nightshift personnel (and corresponding work machines). Each such plan can have a defined start time and a defined end time. As examples, a new short-term plan can be imported for each shift, each day, each week, or each month. Further, the duration(s) of the short-term plan can vary over the life of the mine site 10. For instance, longer short-term plans might be used during start-up and reclamation with shorter short-term plans used during the productive life of the mine site.

Discussed in more detail below, a short interval control (SIC) window, or simply a control window in the context of the present disclosure, can be regarded as a period of time extending from sometime in the past (configurable) through to sometime in the future (forecast period) for which tasks that overlap the period can be shown on one or more specialized operator interfaces (e.g., graphical user interface (GUI)) of the operator control interface 31 on one or more displays of the console 30. For instance, according to one or more embodiments, the SIC window can involve a timeline, that is represented by a horizontal line, divided into a three-hour look ahead portion and a three-hour look behind portion, both from a current time (e.g., as marked and identified by a vertical line) along the timeline i.e., the horizontal line. The SIC window, according to one or more embodiments, can be comprised of two short-term intervals, each three hours long.

The individual outcomes included in the short-term plan may have a variety of associated priorities. For example, an outcome may require that a specific loading tool (e.g., digging machine 52) be saturated (i.e., always has regularly running hauling machines 50). Additionally, or optionally, the short-term plan may indicate that delivering material to a specific destination is a priority (e.g., a highest priority). Thus, the short-term plan can have one or more outcomes (e.g., feed a crusher, undertake planned maintenance, and build a ramp) each having associated therewith one or more attributes (e.g., (i) use loading tools LD1, LD2, and LD3, wherein LD3 may be an alternate to LD1 or LD2, dig from source blocks SB1, SB2, load trucks, dump at crusher, and start at 8 am/finish at 2 pm; (ii) loading tool LD2 to travel to workshop at 2 pm for two hours, wherein completion of maintenance to LD2 can be the outcome (LD2 may return to the job/task after completion of the maintenance); and (iii) loading tool LD3 (which may be a wheeled loader) to build ramp R3 at 10 am for four hours, respectively, for the outcomes to be realized), one or more constraints (e.g., blend block B1), and one or more priorities (e.g., crusher requires a minimum feed rate of X tons per hour; feeding the crusher takes priority over one or more other outcomes such as planned maintenance or building ramp).

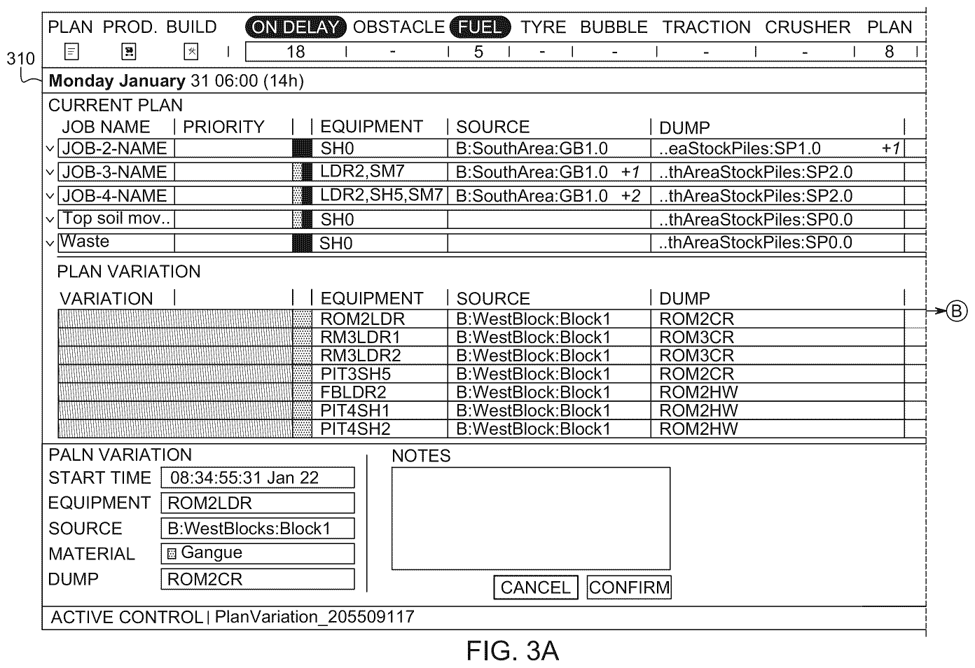

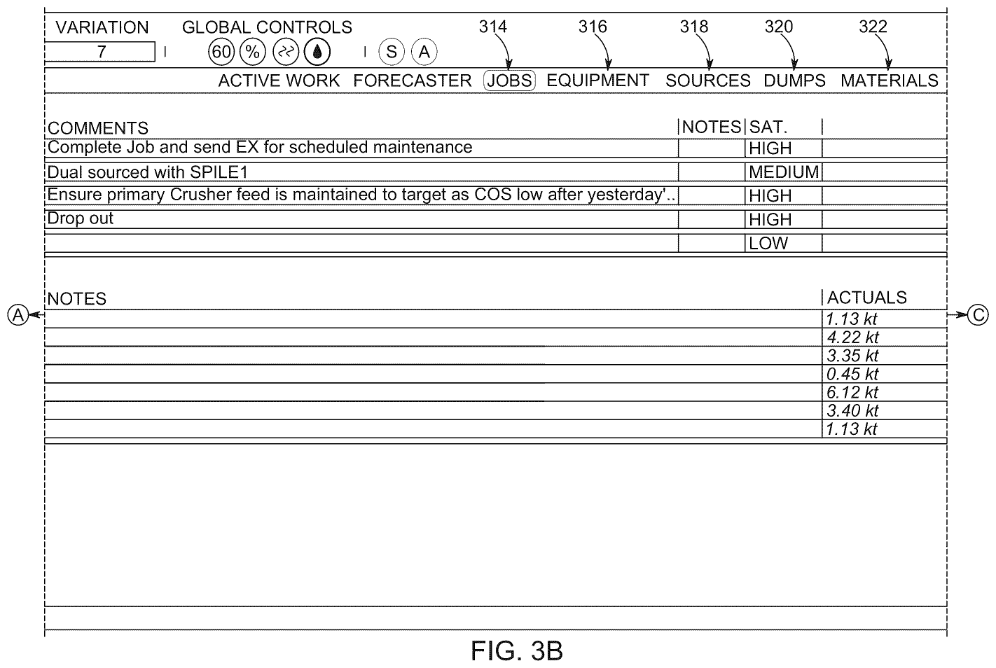

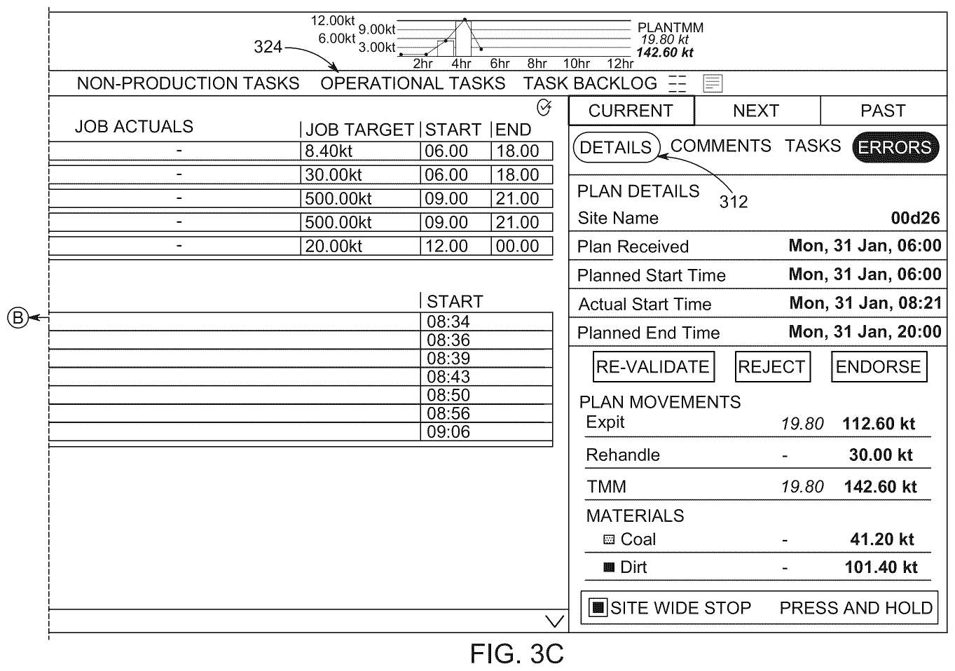

Regarding the preceding paragraph, an alternate loading tool can be regarded as a loading tool which may be used if one or more of the primary loading tools is not available; alternate loading tools may be listed in jobs but may not be defined for tasks. The assumption can be that the primary and alternate loading tools can be set before creating a task. A mining block may be regarded as a specific source of material. Mining block and block may be used herein interchangeably. Thus, an alternate source can be regarded as a mining block that may be used if one or more of the primary sources is not available. Alternate sources may be listed in jobs but may not be defined for tasks. The assumption can be that the primary and alternate sources to be used can be decided before creating a task. A blend can mean a specific mix of materials. Thus, a blended block, in the context of the preceding paragraph, may be regarded as material gathered by multiple loading tools required to work together to produce a specific mix of materials. Referring to FIGS. 3A-3C, the above-discussed source blocks (e.g., source blocks SB1, SB2) may correspond to blocks under ‘SOURCE.’ Likewise, the above-discussed loading tools (e.g., LD1, LD2, and LD3) may correspond to loading tools under ‘EQUIPMENT’ in FIGS. 3A-3C. Of course, equipment is not limited to loading tools, as can be seen from FIGS. 3A-3C.

A production goal can be regarded as a specific type of outcome that specifies an amount of material to be moved over a specific period (e.g., to a crusher). A production target may be qualified to include primary loading tools, alternate loading tools (relative to the primary loading tool(s)), primary source blocks, alternate source blocks (relative to the primary source block(s)), primary destinations, and/or alternate destinations (relative to the alternate destination(s)). The production target may specify that the material is to be loaded in one or more hauling machines 50, to be dumped at the destination by the loading tool (e.g., digging machine 52) (Load Haul Dump (LHD)), or to be pushed by dozers. Additionally, one or more constraints may be added if materials are to be delivered to the destination in a blend (a specific mix of materials) or in a recipe (a dump sequence in which in distinct materials are dumped in sequence).

An operational delay can be regarded as an outcome that specifies that a work machine (e.g., one or more hauling machines 50) is to be put on delay i.e., excluded from production for a period of time. For example, the short-term plan may include a requirement for the work machine to go to a workshop for preventative maintenance.

Non-productive work can be regarded as an outcome pertaining to a task that does not primarily involve the movement of material. Non-productive work may include building roads, road maintenance, building ramps, and watering roads, as some examples.

Drill and blast can be regarded as an outcome that may require that an area, for example, one or more mining blocks be drilled and blasted.

The short-term plan, which may be regarded as a unit of work, once electronically created, can be electronically submitted, or imported, to a computer-readable memory e.g., storage media 36 of one or more processors e.g., a processing circuitry of the controller 20, for instance, and accessed using the console 30. The importation can be via the network 18 (but not necessarily through central station 54) or directly to the controller 20 via a physical electronic file or files e.g., removable memory such as a thumb drive. One or more short-term plans can be selected for importation using the operator control interface 31 and the controller 20, for instance. Here, the short-term plan, or plans, can be electronically imported, for instance, from the planning system 22 to the fleet management system (FMS) 26. According to one or more embodiments, each outcome can be regarded as a job. That is, one or more short-term plans can be imported into the FMS 26 as jobs. Thus, each short-term plan may be regarded as a collection of jobs. Discussed elsewhere, a job can be comprised of one or more tasks. According to one or more embodiments, the jobs associated with an imported short-term plan may include both pre-existing jobs and new jobs. Where the prior short-term plan included jobs that were not completed, such jobs may be repeated or updated when a new short-term plan is imported. Short-term plans may be updated manually, for instance, manually selecting a short-term plan in some format for import, or may be imported automatically, for instance, under the control of an external planning system (e.g., short-term plans may be imported periodically or as required based on changing circumstances). As noted elsewhere, a short-term plan can include a set of jobs with associated priorities. For example, a short-term plan might indicate that specific loading tools must be saturated (i.e., always have hauling machines 50) or that a specific loading tool must have priority over other loading tools. The short-term plan might also indicate which dumps (including crushers) should be given priority. Where a short-term plan says that feeding a crusher is a priority, the loading tools feeding that crusher would also need to be given priority. While the jobs in a short-term play may not be strictly ranked, defined rules may be applied to the associated priorities to create ranked tasks. Where the priorities of individual jobs are identical (or similar) the assigned rank may be arbitrary.

A job can describe material which is required to be moved from a source to a dump, from a source alone, or to a dump alone. The outcome the job is looking to achieve can be pit progression or site product conformance to meet short-term plan objectives. Jobs can be imported as part of plans but may not be able to be added, removed, and/or changed by the controller 20. That is, jobs can be immutable. However, once the jobs are converted to tasks, the task can be added, removed, and/or changed, as needed. Keeping the short-term plan and the related jobs immutable can allows a comparison of what the customer said they wanted (in the short-term plan) to what happened (as defined by the tasks). Further, each job can have a defined start time and a defined end time, each of which can be aligned to the related short-term plan, or at least a portion thereof.

Jobs cannot be used directly to optimize production because they may contain alternatives and complex priorities. In some cases, it may not be possible to implement a short-term plan as imported due to unplanned breakdowns or other operational issues. However, to enhance i.e., optimize or automate production activities the imported short-term plan, and the one or more jobs therein, can be used to create ranked tasks. The controller 20 of the present disclosure can be used to create a ranked list of tasks. In particular, tasks initially may be created and even ranked, or prioritized, automatically. Task ranking can be applied to production tasks to tell an assignment function which task targets need to be met before others. As an example, tasks can automatically get the highest rank if they are a task with a blend. Further, the controller 20, via input to the operator control interface 31 of the console 30, for instance, can modify and reprioritize the tasks as required. For example, the controller 20 may change, via the operator control interface 31, the preferred loading tool to an alternate loading tool, or may change the planned start or end times to account for local conditions e.g., weather, staff shortage, or machine breakdown. Optionally, the controller 20 can create one or more additional tasks as required for each job. Changing or creation of tasks may be performed via input to the operator control interface 31, for instance, via text input; a drop-down menu of preset tasks, or task assignment values; dragging and dropping, voice input, or with performance of other types of inputs for control known to persons skilled in the art.

A task can represent the activity and resources which describes the “who,” “what,” and “when” required to execute a job. A task may also represent a planned down time event which impacts work machine availability or when a work machine is required for non-production tasks. Tasks can run in parallel or be sequential. Tasks may not only be referred to for activities by the load and haul fleet but can also be the required activities of auxiliary equipment. Tasks can change during a shift; however, in general, if the plan does not change, jobs should not change. Further, unlike jobs, tasks may be added, edited, or deleted. Tasks may also take a number of forms, including a production task, an operational task, a non-production task, and a variation task.

A production task can be regarded as a task which has a primary purpose to manage the movement of material as a primary production activity. Discussed in more detail below, the execution of production tasks can be enhanced i.e., automated or optimized by assignment by, or using, the controller 20. Primary production can be regarded as a unit of work that directly contributes to the delivery of a product to a customer. As examples, primary production may include clearing topsoil or waste to uncover an ore body, moving material to a stockpile or a crusher, pushing material to uncover an ore body or pushing material to load a train.

An operational task can be regarded as a task which makes a work machine, or another asset, unavailable to perform production or non-production tasks. Scheduled breaks (delays), refueling (scheduled assignments), and maintenance (scheduled assignments) may all be classified as operational tasks. An operational task may also be referred to herein as a planned delay.

A non-production task can be regarded as a task which calls for work to be done that is not directly related to primary production. Cleaning up batters, building roads and ramps, and grading are examples of non-production tasks. Some non-production tasks may include material movements. For example, a dozer building a ramp may require that some material be delivered to the construction site. Another example of a non-production task is road grading.

A variation task can be regarded as production activity which could not be matched to a defined task. A variation task can also be regarded as an undefined task. Like a production task, a variation task can capture equipment, material, mining block, source, and dump details where mining has occurred outside of the plan. There can be variations at both the job and task level. A variation at the job level can indicate that work was performed that was not in the short-term plan. A variation at the task level indicates that work was performed that was not included in a defined/planned task. These may be very different things where tasks have been defined, for instance, using the controller 20, that do not align with the active short-term plan (jobs). Initially, a variation task can highlight that work is being done that is not related to a defined job or task. A variation task may be responded to, for instance, using the controller 20, in a number of different ways, including providing instructions to stop the unplanned work, determining that the unplanned work is required and converting the variation task into a planned task, and/or modifying an existing task or creating a new task to cover the unplanned work. Thus, according to one or more embodiments, an undefined task can be simply meant to highlight that a variation task can be converted into a planned task. As an example of a variation task, if something unexpected happened at the mine site 10, one or more variation tasks can be created and accessed, using the controller 20 and the operator control interface 31, to identify occurrences at the mine site 10 that were not planned.

A production plan can be regarded as a product of assignment which can include a complete set of production arcs for the mine site 10. A production arc can be regarded as a component of a production plan which indicates the rate at which material is to be moved from a specific loading tool (e.g., digging machine 52) to a specific processor (e.g., processing plant 48). Production arcs can be produced by the assignment engine 27 based on the latest available production plan. It may be noted that there would only be one production arc defined for each loading tool (e.g., digging machine 52) and processor (e.g., processing plant 48) pair regardless of how many jobs and tasks are assigned to a specific loading tool and processor pair from amongst multiple pairs of loading tools and processors.

A forecast rate can be regarded as a rate over a specific time period for a specific machine. The forecast rate may be used to compile metrics and predict completion times for auto-assigned tasks (‘Ready’ and ‘Available’ tasks). According to one or more embodiments, forecast rates may be produced by the forecasting engine 28 for ‘Ready’ and ‘Available’ tasks. Optionally, there may be multiple forecast rates for a single work machine (e.g., one of the hauling machines 50) during a given time period where the work machine is referenced in, or assigned with, multiple tasks. A forecast arc can include start and end times so that changes in forecast production rates may be modeled across planned delays (i.e., operational tasks).

An auto task workflow can be regarded as a workflow that can be used for tasks that will be executed through automated process as discussed in detail below. As such, the controller 20 can use assignment to enhance i.e., optimize or automate the execution of production tasks for primary production. A manual task workflow can be regarded as a workflow used for tasks that will be executed for manual process. The manual process could be the manual selection or assignment of a task by an operator. A manually assigned workflow can be used for operational tasks (i.e., delays). In plan management terms, a scheduled assignment may be regarded as a form of operational task. For example, if an operator created an operational task for one of the hauling machines 50 to park up for shift change, this can be implemented as a scheduled assignment to travel to the park up and then go on delay. Thus, the manual workflow can be used for operational tasks and scheduled assignments.

A specialized analyzing operator interface of the operator control interface 31 can be used, or accessed, to analyze and understand the selected short-term plan (or plans), along with any comments pertaining to the short-term plan and/or plan movements (e.g., the required work machine moves at the mine site 10). The specialized analyzing operator interface may be in the form of a graphical user interface (GUI). Hence, for purposes of the present disclosure, the specialized analyzing operator interface can be considered as a specialized analyzing operator graphical user interface. Additionally, or optionally, one or more processors of the controller 20 can automatically and electronically review the selected short-term plan, or plans. In use i.e., prior to execution of an upcoming short-term plan, or plans, the upcoming short-term plan, or plans, can be imported and checked, using the controller 20 and the specialized analyzing operator interface of the operator control interface 31, prior to an upcoming shift to which the upcoming short-term plan, or plans, correspond.

Generally, the specialized analyzing operator interface can provide planning and/or management information such as the short-term plan or plans, the job or jobs associated with the short-term plan(s), the task or tasks associated with each job (e.g., operational tasks and/or non-production tasks), available equipment, sources, dumps, materials, status of each of the tasks, etc. Such planning and/or management information may be provided on separate individual pages, for instance, accessed by respective individual tabs. The specialized analyzing operator interface may also include a prioritization or ranking for the tasks, for instance. Optionally, each task associated with a job may be ranked or prioritized. Thus, the specialized analyzing operator interface may show an absolute prioritization of the tasks and/or a prioritization of the tasks under each job. According to one or more embodiments, the information shown by the specialized analyzing operator interface (e.g., each tab) may be referred to or characterized as a jobs view or views.

Task backlog information may also be shown on or accessed by the specialized analyzing operator interface. Such task backlog information may indicate all tasks (including ‘Closed’), for instance, sorted by short-term plan and shift (if no short-term plan currently available). Thus, the specialized analyzing operator interface can be used to access one or more jobs views to analyze the jobs and production tasks, for instance, using the controller 20, in conjunction with the specialized analyzing operator interface, to ensure that production can be executed.

The specialized analyzing operator interface may show an initial prioritization (ranking) of the tasks automatically produced using the controller 20, as well as an updated prioritization (which may include newly added tasks) using the specialized analyzing operator interface, particularly where the ranked tasks can be tasks that may need to be worked over a particular period of time to accomplish a particular job. Thus, tasks can be generated for every job imported into the short-term plan.

Thus, the controller 20 and optionally the specialized analyzing operator interface can create a ranked set of tasks in compliance with the short-term plan. Also using the controller 20 and the specialized analyzing operator interface (and optionally the input device 32), one or more of the ranked tasks can be modified. The operator, using the specialized analyzing operator interface, may drop and drag the tasks, make notations to the tasks, etc. to set or change the ranking and other aspects of the tasks. Discussed in more detail below, the prioritized tasks can be automatically processed by the assignment engine 27 to perform task-based management and scheduling (e.g., enhanced or optimized work machine allocation) for the job(s) of the mine site 10.

Here, the automatically created initial ranked tasks can be ranked according to a predefined relative priority (i.e., no absolute priority). The tasks can thus be provided in an ordered list, where the first task on the list is the most important, the second task on the list is the second-most important tasks, and so on down the list. The automatically created initial ranked tasks may be referred to or characterized as ‘New’ tasks. When a new short-term plan is imported (and activated), an initial set of tasks can be automatically created from the jobs in the short-term plan. These system-generated tasks can be automatically ranked by applying defined rules to the various priorities included in the short-term plan.

One or more additional new tasks can be created using the controller 20 and using the specialized analyzing operator interface, as required, for instance, for any work not already included. According to one or more embodiments, such one or more new tasks may also be referred to or characterized as ‘New’ tasks, as defined herein. Such ‘New’ tasks, whether initially automatically ranked or newly created, can be validated using the controller 20 and/or the specialized analyzing operator interface. For any tasks coming back invalid, such tasks can be modified and re-validated using the controller 20 and/or the specialized analyzing operator interface.

Tasks may also take a number of different states in addition to the ‘New’ state, including a ‘Ready’ state, an ‘On Hold’ state, an ‘Available’ state, a ‘Closed’ state, and an ‘Active’ state. The states, collectively, may be referred to or characterized as a “life cycle” of a task.

‘New’ state can mean that a task is not yet complete for application to production. This may include partial tasks or tasks pending review. In some respects, a ‘New’ task may be referred to or characterized as a so-called quarantined task, i.e., presently quarantined from production.

‘Ready’ state can mean that a task is complete and ready for production use but has not yet been released to production. According to one or more embodiments of the present disclosure, ‘Ready’ state may be used only with automatic tasks. ‘Ready’ tasks, according to embodiments, may be a complete task (versus partial or unfinished) in a prioritized backlog, for instance. Thus, a ‘Ready’ task may be a task to be performed that has yet to be handed over to the assignment engine 27 to be actively worked on.

‘On Hold’ can indicate a task that was previously ‘Available’ but was subsequently removed from a backlog for a current production period (shift). According to one or more embodiments of the present disclosure, the ‘On Hold’ state may be used only with manual tasks.

‘Closed’ state can indicate that no further work will be done for a task. A ‘Closed’ task may be considered historical. Further, tasks in the ‘Closed’ state may have been completed, abandoned, or cancelled. ‘Closed’ can mean that the task is no longer being tracked by the forecasting engine 28 or the assignment engine 27.

‘Available’ state can be regarded as a task that is complete and ready for production. For automatic tasks, the task has been released for automatic scheduling and execution. For manual tasks, the task is available for selection (activation), for instance, using the controller 20 and optionally the specialized analyzing operator interface 310. According to one or more embodiments of the present disclosure, where an ‘Available’ task has a future start time, such ‘Available’ task should not be automatically scheduled or made available for selection until the designated start time. According to embodiments of the present disclosure, all ‘Available’ tasks may be required to be able to work together without conflict within the constraints of the current mine model.

The foregoing may be considered to effectively impart an agility to the management of production tasks for the mine site 10, particularly where ‘Ready’ tasks can form a backlog and ‘Available’ tasks defined over a short interval control (SIC) window can define the active work. Discussed in more detail below, active work can be or include those tasks in ‘Available’ with a start time as now or in the past and an end time in the future. According to one or more embodiments, when using an “Agile Methodology,” work can be organized into relatively short intervals (e.g., two weeks) where the most important or valuable work is selected for each “sprint.” This can allow for teams to respond quickly to changing circumstances or business priorities, since teams can change their priorities, for instance, every two (2) weeks (i.e., every “sprint”). “Sprint,” therefore, may be regarded as a relatively short, time-boxed period when team works to complete a set amount of work.

An ‘Active’ task, in the context of the present disclosure, can be regarded as a task where some associated work has been performed recently (e.g., within the last sixty (60) minutes). Associated work, in the context of the present disclosure, can be regarded as a completed or an in-progress cycle which matches the attributes of the task. Only ‘Available’ tasks can be marked as ‘Active’; however, according to one or more embodiments, ‘Ready’ tasks may also be marked as ‘Active’ for some use cases. Here, the system can mark the task as ‘Active’ when cycle activity matches the task. As an example, a ‘Ready’ task might call for a loading tool to dig material M from mining block B. Where the loading tool is still digging a different material from a different mining block, the ‘Ready’ task would be marked as “inactive.” However, once the loading tool started to dig material M from mining block B, the ‘Ready’ task may be marked as “active.” The same could be said for an ‘Available’ task, even though ‘Available’ tasks can be passed to Assignment, where Assignment actively sends hauling machines 50 to the associated loading tool to implement the task, and where the loading tool might still be digging a different material in which case the ‘Available’ task would remain “inactive.”

Tasks in the ‘Available’ state can be used to set dynamic production goals for the assignment engine 27 over a short interval control (SIC) window. As discussed above, the SIC window, or simply a control window in the context of the present disclosure, can be regarded as a period of time extending from sometime in the past (configurable) through to sometime in the future (forecasting period) for which tasks that overlap the period can be shown on one or more specialized operator interfaces e.g., graphical user interface (GUI) of the operator control interface 31 on one or more displays of the console 30.

All validated tasks may then be prioritized, by or using the controller 20 and optionally the specialized analyzing operator, as ‘Ready’ tasks. Discussed in more detail below, a ‘Ready’ task may be ready to be provided to the forecasting engine 28 (‘Available’ tasks can also be provided to the forecasting engine 28).

Some or all of the validated tasks that are approved for production can be selected using the controller 20 and optionally the specialized analyzing operator interface. This can mean that the status of each task is transformed to ‘Available.’ The ‘Available’ state can mean that a task is complete and ready for production. In the case of automatic tasks, the task has been released for automatic scheduling and execution using the controller 20. And in the case of manual tasks, the task is available for selection (activation), for instance, using the controller 20 and optionally the specialized analyzing operator interface. ‘Available’ tasks can be passed to the assignment engine 27, as noted above, for the assignment engine 27 to determine a configuration to implement (e.g., enhance, optimize, automate) completion of the task.

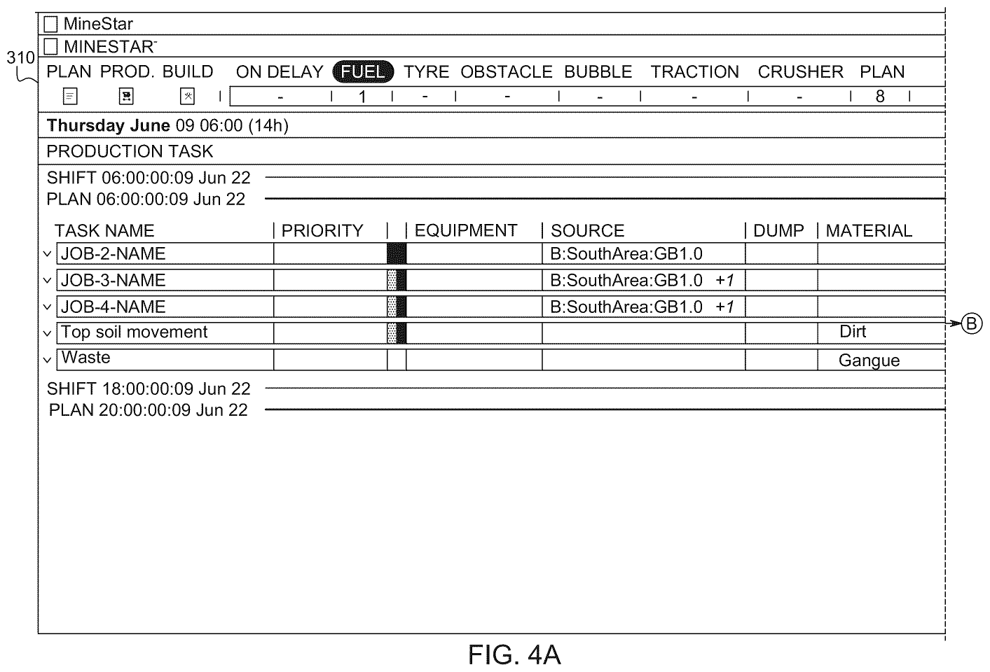

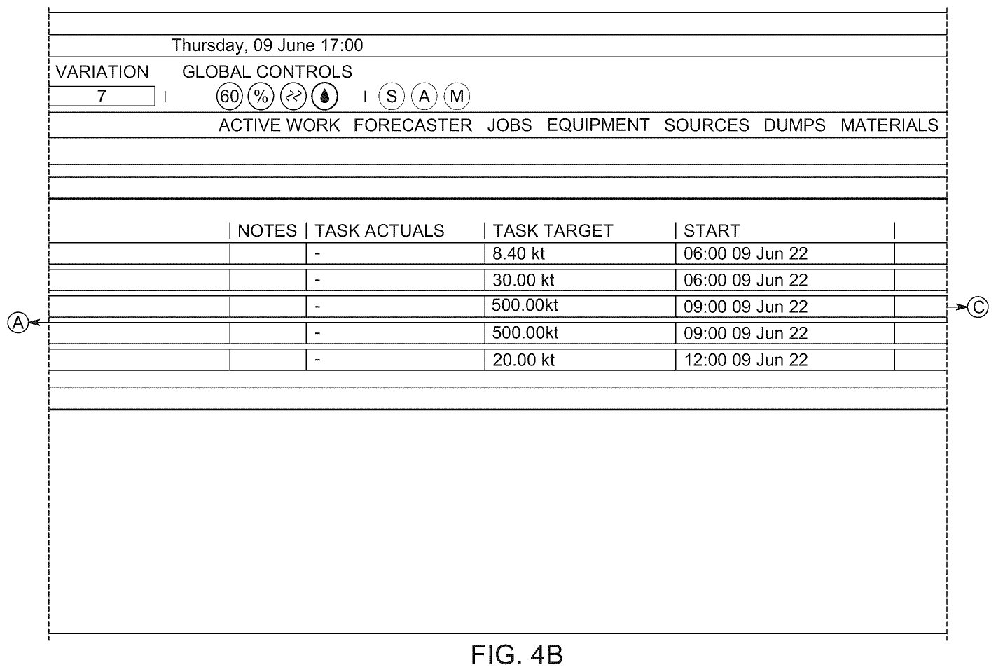

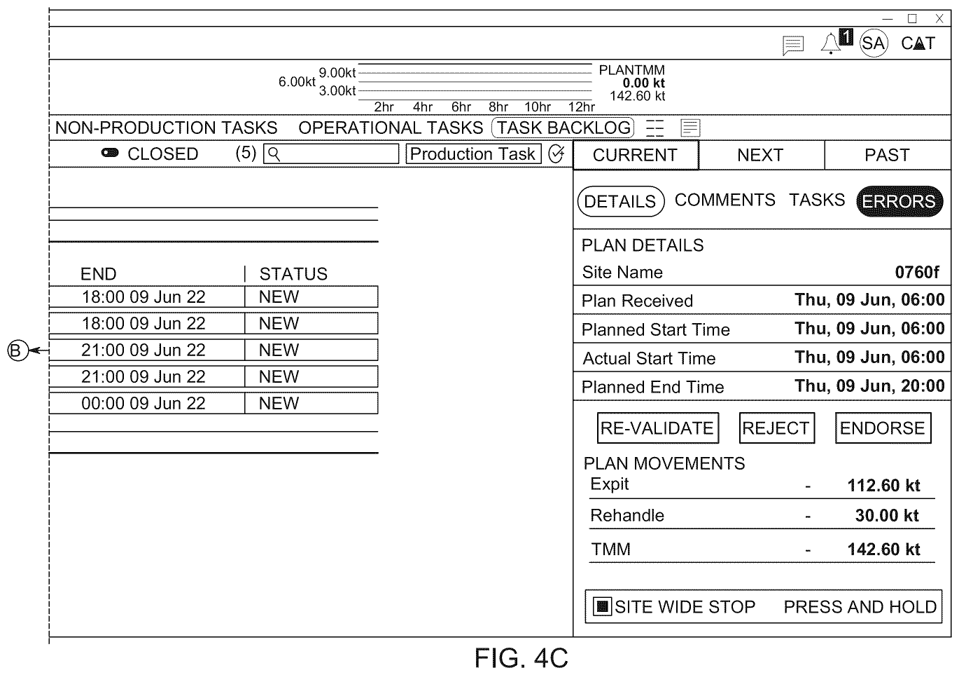

Referring again specifically to the specialized analyzing operator interface, as noted above, the specialized analyzing operator interface can provide planning and/or management information such as the short-term plan or plans, the job or jobs associated with the short-term plan(s), the task or tasks associated with each job (e.g., operational tasks and/or non-production tasks), equipment, sources, dumps, materials, status of each of the tasks, prioritization or rank for the tasks, and task backlog information. FIGS. 3A-3C and FIGS. 4A-4C show examples of specific portions, i.e., features, pages, views, or tabs, of a specialized analyzing operator interface 310 according to one or more embodiments of the present disclosure. Typically, the specialized analyzing operator interface 310, including one or more of the portions shown in FIGS. 3A-3C and/or FIGS. 4A-4C, can be accessed towards the end of a shift to check an upcoming plan to set up the next shift for success.

Notably, the specialized analyzing operator interface 310 portion in FIGS. 3A-3C can have, among other features, a Details feature 312 to access plan details, as well as a Jobs feature 314 to access jobs from plan and production tasks, and an Equipment feature 316, a Sources feature 318, a Dumps feature 320, a Materials feature 322, and a Tasks feature 324 associated with the short-term plan, for instance, sorted by entity mentioned in the Jobs feature to provide access to the jobs for each loading tool, the source(s), the dump(s), the material(s), and required target(s). According to one or more embodiments, the Jobs, the Equipment, the Sources, the Dumps, the Materials, and the Tasks (non-production and/or operational) features 314-324 can be collectively referred to or characterized as Jobs features, views, pages, or tabs. Here, generally, the Details feature 312 may provide access to review comments and plan movements; the Jobs features, collectively, can provide access to analyze jobs and production task details to ensure production can be executed, to analyze non-production tasks and/or operational tasks, and to create one or more new tasks for any work not already included. The specialized analyzing operator interface 310 portion in FIGS. 3A-3C may also provide access to a Forecaster feature 328 (or view, page, or tab) and an Active Work feature 329 (or view, page, or tab) associated with the forecasting operation and the active work operation, respectively, which are discussed later.

The specialized analyzing operator interface 310 portion in FIGS. 4A-4C can be referred to or characterized as a Task Backlog feature 326, view, page, or tab. Optionally, the specialized analyzing operator interface 310 portion of FIGS. 4A-4C can be accessed from the specialized analyzing operator interface 310 portion of FIGS. 3A-3C. As noted above, task backlog information may indicate all tasks (including ‘Closed’), for instance, sorted by short-term plan and shift (if no short-term plan currently available). Here, generally, the Task Backlog feature 326 can provide access to analyze whether tasks on backlog are still required for a particular shift e.g., the current or next shift.

The specialized analyzing operator interface 310, in conjunction with the controller 20, can select all or some of the tasks (i.e., a subset of all of the tasks). Here, such selection may be in response to operator input to the specialized analyzing operator interface 310. According to one or more embodiments, such candidate tasks may be tasks in the ‘Ready’ state. To select each task, the task, having already been transitioned from ‘New’ to ‘Ready,’ may be transitioned, using one or more inputs to the specialized analyzing operator interface 310, from the ‘Ready’ state to the ‘Available’ state. The ‘Available’ state, as noted above, can be indicative of when the task is ready to be executed. Optionally, individually or as part of a batch process, the specialized analyzing operator interface 310, in conjunction with the controller 20, can confirm validation and check for errors of the selected tasks, i.e., the ‘Available’ tasks. Such selection of tasks, i.e., moving all or some of the tasks from ‘Ready’ to ‘Available,’ can make the tasks ready to be executed available for processing by the assignment engine 27, the forecasting engine 28, and/or the active work engine 29.

According to one or more embodiments of the present disclosure, the system can separate the assignment processing (i.e., execute to plan for production optimization), which may be relatively more computationally complex, from the forecasting processing, i.e., forecast to plan, which may be relatively less computationally complex than the assignment processing, so the forecasting processing can provide immediate feedback, via the controller 20 and the operator control interface 31, regarding the impact of changes (at the mine site 10 and/or via operator input to the operator control interface 31). Optionally, the forecasts for individual tasks can be rolled up into Spark Charts (discussed in more detail below) which can provide the operator control interface 31, under control of the controller 20, with an immediate visual indication of task viability. Spark Charts, in the context of the present disclosure, may be referred to or characterized as a specialized short interval control (SIC) operator interface. As noted above, sets of tasks, production arcs, and forecast rates, as defined herein, may constitute an integration point between the assignment engine 27 and each of the forecasting engine 28 and the active work engine 29 or components thereof, such as the above-mentioned specialized short interval control (SIC) operator interface and a to-be-discussed specialized active work operator interface, respectively.

### Assignment

Addressing first in more detail the assignment feature, assignment may be referred to or characterized as backend processing by the assignment engine 27 to assign tasks, for instance, to enhance (automate or optimize) the completion of tasks, i.e., compliance to plan over time, rather than necessarily optimizing to static production rates, i.e., compliance to static rates. That is, the assignment engine 27 can, based on the inputs thereto (e.g., mine plan or plans, mine site data (e.g., received in real time and/or historical), machine-related data (e.g., telemetry data received in real time and/or historical, status data), and/or operator-related data), automatically identify and allocate an enhanced (e.g., optimal) configuration of entities (e.g., work machines and/or operators) to complete each task of the short-term plan. Thus, assignment engine 27, in the context of the present disclosure, can be regarded as a processing engine, implemented in or using the controller 20, that can perform a process (or be or include the process itself) by which a specific person or work machine is directed to perform a particular task. A production plan, with a complete set of production arcs, may be a product of the assignment operation. Here, notably, the assignment engine 27, rather than focusing on a particular point in time, i.e., rate and material of a work machine at the particular point in time, can focus on a production plan expressed as a set of tasks for a window of time (e.g., three hours) in an effort to finish as many tasks as possible (e.g., all of them) in this window of time.

For instance, assignment, in the context of the present disclosure, can optimize the assignment of hauling machines 50 to best achieve a production plan. Rather than the assignment engine 27 being configured to achieve static production rates over a period of time for an entered production goal or goals, where the production goal(s) may only provide information about a single point in time and may not include future predictions (e.g., Material A to be dug by Loading Tool B at a rate of C tons per hour and to be dumped at Destination D), where when circumstances change the static production rates would need to be adjusted to match the changes circumstances, embodiments of the present disclosure, for assignment, can enter tasks that define an amount of material to be moved over a period of time (e.g., A tons of Material B to be dug by Loading Tool C and dumped at Destination D starting at time E and ending at time F). Although a task does imply an average rate over a period, it does not specify what the rate should be at any given point in time. In this example, the assignment engine 27 may vary the rate at which Loading Tool C digs from time-to-time, for instance, as long as the average rate is achieved over the specified time period. Hence, the assignment engine 27, according to embodiments of the present disclosure, can provide information about a current point in time as well as future points in time. Information regarding points in time prior to the current point in time may also be provided. Though assignment has been referred to in relation to the hauling machines 50, embodiments of the present disclosure are not so limited, and assignment can pertain to other types of vehicles, such as water trucks.

As another example, two tasks might be defined for a loading tool where one task says to move material to Dump A and a second task says to move material to Dump B, by a set time. Even where only Dump A is available, the loading tool can be controlled to work at a rate that will allow for the completion of both tasks by the set time, e.g., complete the first task early.

As yet another example, suppose we have a plan expressed as two tasks to be completed: Task 1—Loader A to dig 150,000 tons from Source Block Q and send it to Crusher 1 over the next two hours; and Task 2—Loader A to dig 50,000 tons from Source Block Q and send it to Crusher 2 over the next hour. In this example, the Loader A may be only able to dig at a rate of 100,000 tons per hour. If we convert these to static rates and Task 1 in a higher priority we will get Loader A digging 75,000 tons for Task 1 in the first hour and Task 2 digging only 25,000 tons. So Task 2 will finish late. However, implementing the assignment engine 27 according to embodiments of the present disclosure, the assignment engine 27 can have Loader A do 50,000 tons for Task 1 and 50,000 tons for Task 2 in the first hour, and then 100,000 tons for Task 1 in the second hour. Following this approach, both tasks can be completed on time.

Accordingly, with visibility to both current and planned tasks, the assignment engine 27 may dynamically adjust production rates (e.g., the allocation of hauling machine(s) 50 to digging machine(s) 52) to allow for a maximum number of ‘Available’ tasks to be completed on time. Assignment supporting dynamic production rates can reduce or eliminate the requirement for constant monitoring and adjustment of static rates and can improve compliance to plan over the SIC window. The allocation of ‘Available’ tasks over a SIC window may be referred to or characterized as dispatch to plan using short interval control. Put more generally, the assignment engine 27 can take ‘Available’ tasks and also other input data (e.g., mine plan or plans, mine site data (e.g., received in real time and/or historical), machine-related data (e.g., telemetry data received in real time and/or historical, status data, etc.), and/or operator-related data), identify and allocate a best or optimal configuration of entities (e.g., machines and/or operators)) based on the ‘Available’ tasks and input data, and determine how best to coordinate the activities of some or all of the work machines to achieve the tasks of the short-term plan.

Here, according to embodiments of the present disclosure, the assignment engine 27 can consider all ‘Available’ tasks defined over a short interval control (SIC) window. More specifically, the ‘Available’ tasks that overlap the SIC window can be determined, for instance, by or using the controller 20, and passed to assignment. ‘Available’ tasks can include both production and operational tasks, e.g., delays. The assignment engine 27 can, for instance, assign hauling machines 50 (e.g., trucks) to loading tools, such as digging machines 52, i.e., dynamic rates. In this regard, the assignment engine 27 can assign the hauling machines 50 to loading tools seeking to complete as many tasks as possible on time in rank order. Here, the assignment engine 27 may vary hauling machine 50 allocations where such variations allow for more tasks to be completed on time. Thus, according to embodiments of the present disclosure, hauling machine 50 allocations may change dynamically to adapt to changing circumstances, e.g., delays.

In practice, with respect to ‘Execute to Plan,’ the ‘Available’ tasks (in the SIC window) can be handed off to the assignment engine 27 which can use these tasks to produce a production plan and assign hauling machines 50. As noted earlier, a production plan, with a complete set of production arcs, may be a product of the assignment operation. Each time the assignment engine 27 produces a new production plan, forecaster arcs related to the ‘Available’ tasks can be updated. This can provide responsive feedback regarding the feasibility of all ‘Available’ tasks taking into consideration, for instance, the current state of the mine model, assignment groups, locks and bars, and hauling machine 50 availability/distribution. To start or initiate the assignment operation, the task status, individually or as a batch, merely may need to be changed to ‘Available.’

In the case of production tasks, production tasks can be implemented by the assignment engine 27 assigning, for instance, hauling machines 50 in accordance with the defined tasks. Assignment can be configured by “converting” tasks into extended production goals, extended blends, and extended mining block locks, as an automated process. Thus, the assignment service can support the “conversion” of tasks to production goals and blends. Such support can also involve mining block locks with multiple destinations, production goals with multiple loading tools, materials, and processors, and/or blends with multiple loading tools. Regarding “conversion,” the assignment engine 27 can use production requirement information that may be detailed in the task to make the production plan.

An extended production goal can be regarded as a production goal created from the available tasks which may include multiple loading tools, materials, and dumps. Extended blends can be regarded as a blend applied to one or more dumps when a blend task transitions to the available state. Extended mining block locks can include multiple loading tools and multiple dumps. Unlike legacy blends, material for extended blends may be sourced only from the referenced loading tools. Extended production goals will be created for tasks and will allow for multiple loading tools, multiple materials, and multiple processors. Extended blends will be created for tasks and will support multiple loading tools and multiple processors. Extended mining block can be regarded as a mining block lock created from the available tasks which locks a mining block to multiple destinations. Extended mining block locks will be created for tasks and will allow for mining blocks to be locked to multiple destinations; extended mining block locks will effectively override legacy.

Optionally, tasks may replace mining block locks. In particular, mining block locks can be directly encoded in jobs and tasks. Thus, the notion of mining block locks as an attribute of mining blocks can be removed. This can make mining block locks directly aligned with the current short-term plan, which can eliminate configuration errors and prevent the need for an audit of the mining blocks to make sure that any defined destination locks are consistent. As an example, for a single task that required Loading Tool A to dig from Source Block B and send that material to Dump C, a mining block lock can be automatically created to lock Source Block B to Dump C so that any material dug from Source Block B may only be assigned to Dump C.

According to one or more embodiments, the allocation of work machines (e.g., hauling machines 50) to tasks may be based on spatial attributes. For instance, the assignment engine 27 may automatically assign work machines (e.g., hauling machines 50) with tasks based on the work machines' proximity to a referenced source block or other spatial attribute of the task. Non-production tasks may be assigned to auxiliary work machines based on their proximity to the related designs, e.g., road construction or ramp construction. The assignment engine 27 can allocate a particular hauling machine 50 to a particular task if the assignment engine 27 determines that the hauling machine 50 is in a particular location and the particular task to complete is at or near that location.

According to one or more embodiments, the assignment engine 27 can output information regarding the allocation of work machines on a per-task basis, as described above. The controller 20 can electronically output signaling to the mine site 10 to provide instructions or commands for the assignment of the work machines and also for the assigned work machines to perform the tasks at the appropriate time and at the appropriate rates. Such signaling may be to the central station 54 and/or the hauling machines 50 and digging machine 52, either directly or indirectly through the central station 54.

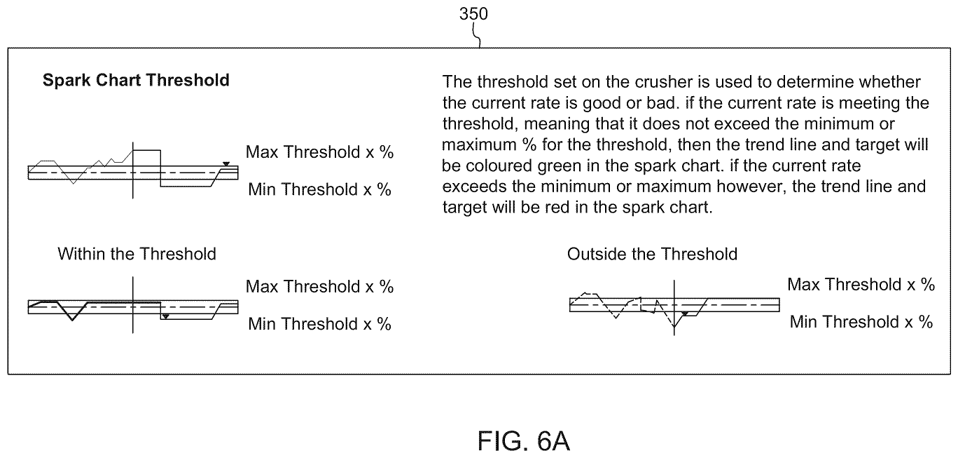

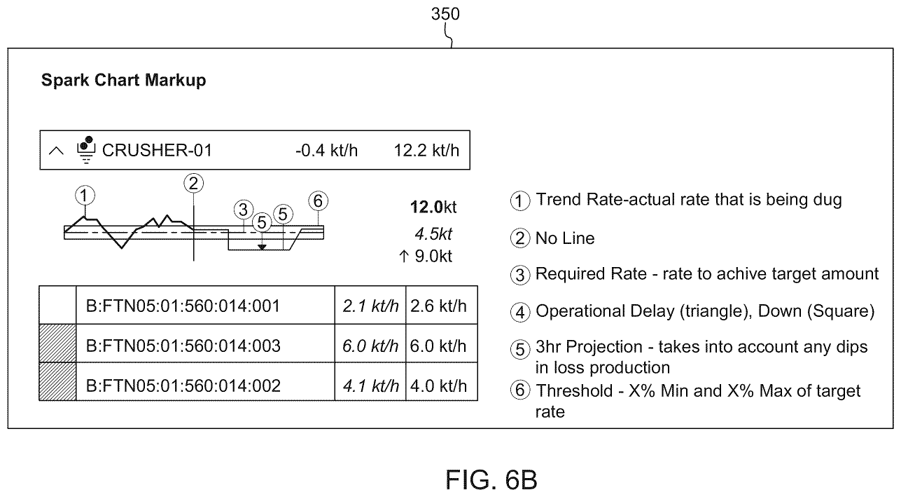

Outputs from the assignment engine 27 can be represented in or by a specialized management operator interface 330. FIG. 6 shows a specific example of a specialized management operator interface 330 according to one or more embodiments of the present disclosure. The specialized management operator interface 330 may be in the form of a graphical user interface (GUI). It is noted that aspects, e.g., visuals or functionality, of the specialized management operator interface 330 associated with some or all of the assignment operations may overlap aspects, e.g., visuals or functionality, of some or all of the forecasting feature. Hence, the specialized management operator interface 330 may also be associated with the so-called forecasting or Forecaster, which is discussed in more detail below.

The specialized management operator interface 330 may operate under control of the controller 20, displayed on the operator control interface 31 of the console 30, for instance. Here, the specialized management operator interface 330 can show planned tasks over a set time horizon (e.g., six-hour short interval control (SIC) window). The specialized management operator interface 330 can be accessed to dynamically adjust tasks within the set time window to achieve or optimize compliance to plan.

Among other features, the specialized management operator interface 330, such as shown in FIG. 6, can include a vertical line to signify present time. Optionally, another vertical line prior to and/or after the current timeline may be provided to signify a shift change. Generally, the horizontal indicia with information can be representative of tasks. That is, each horizontal indicia with information can be characterized as or represent tasks per loading tool. Optionally, the tasks may be grouped on a per-job basis. Such horizontal indicia can thus include tasks with one loading tool, tasks with two loading tools, etc. Here, the horizontal oval indicia can represent each task.

The specialized management operator interface 330 can also indicate the total number of tasks, for instance, showing a target number of tasks in a specific color, such as white, and actual number of tasks in another specific color, such as blue. Information to the left of the ‘Now’ vertical timeline can indicate prior information, i.e., actual information or data calculated from operations performed at the mine site 10, and information to the right of the ‘Now’ vertical timeline indicate future information, i.e., a forecast for operations to be performed at the mine site 10. Here, the information to the right of the ‘Now’ vertical timeline may update or otherwise be presented on the specialized management operator interface 330 more quickly than the information to the left of the ‘Now’ vertical line.

The information provided by the specialized management operator interface 330 can identify compliance to plan, that is, current and forecasted information regarding whether progress is according to plan or not. This can indicate behind schedule or even ahead of schedule. In this regard, the specialized management operator interface 330 can identify which aspects are progressing according to plan and which aspects are not progressing according to plan. Here, cycles can be allocated to individual jobs and tasks so that the specialized management operator interface 330 can provide direct feedback.

Among other information, the specialized management operator interface 330 can provide access to task rank, actual/target/forecast of the task, whether the task has any associated validation errors and therefore cannot be executed, whether an entity (e.g., work machine) associated with the task is in the correct state, the status of the task, e.g., represented by unique indicia, whether the task is a blended task, whether the task target will be met and when, e.g., earlier than end of time task or after the planned end of time of the task, and whether the task is undefined. FIG. 6 is annotated to highlight some of the foregoing aspects.

Optionally, a list of new tasks may be shown on the right of the specialized management operator interface 330. The specialized management operator interface 330 can be used to select one or more of such new tasks to transition to ‘Ready’ (and ultimately ‘Available’). This can involve the operator providing one or more inputs to the specialized management operator interface 33, e.g., drag and drop, pull down menu, or buttons, to select the one or more new tasks to transition to ‘Ready.’

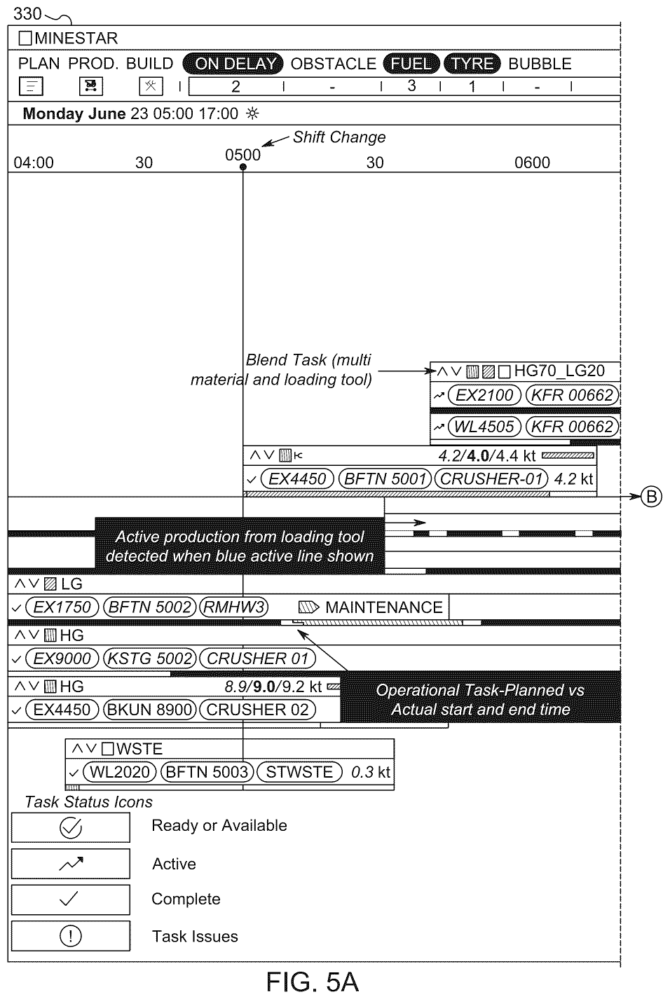

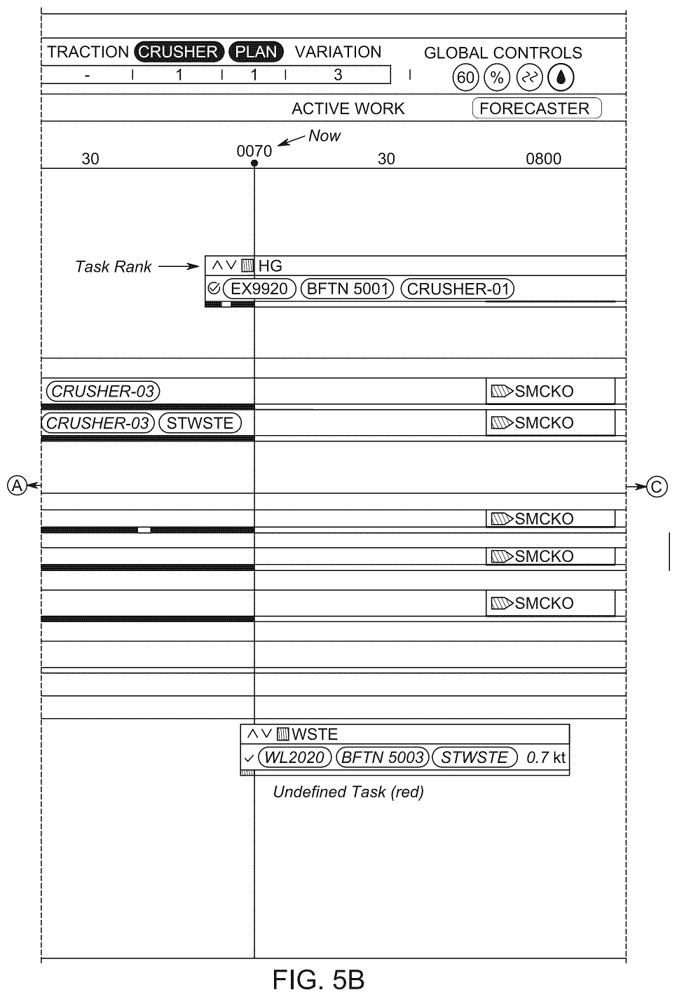

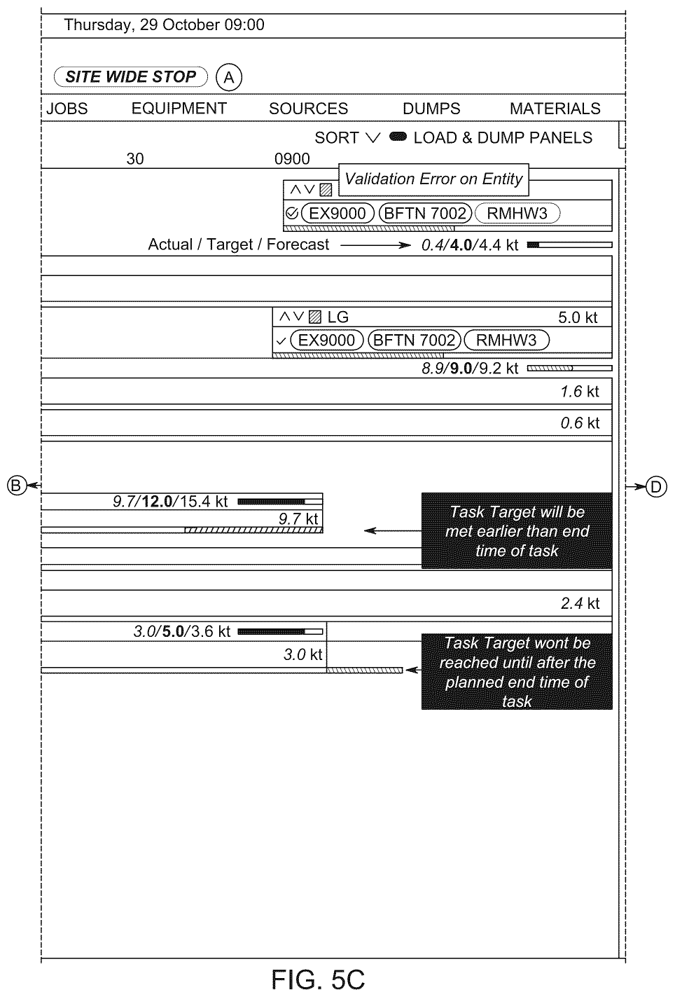

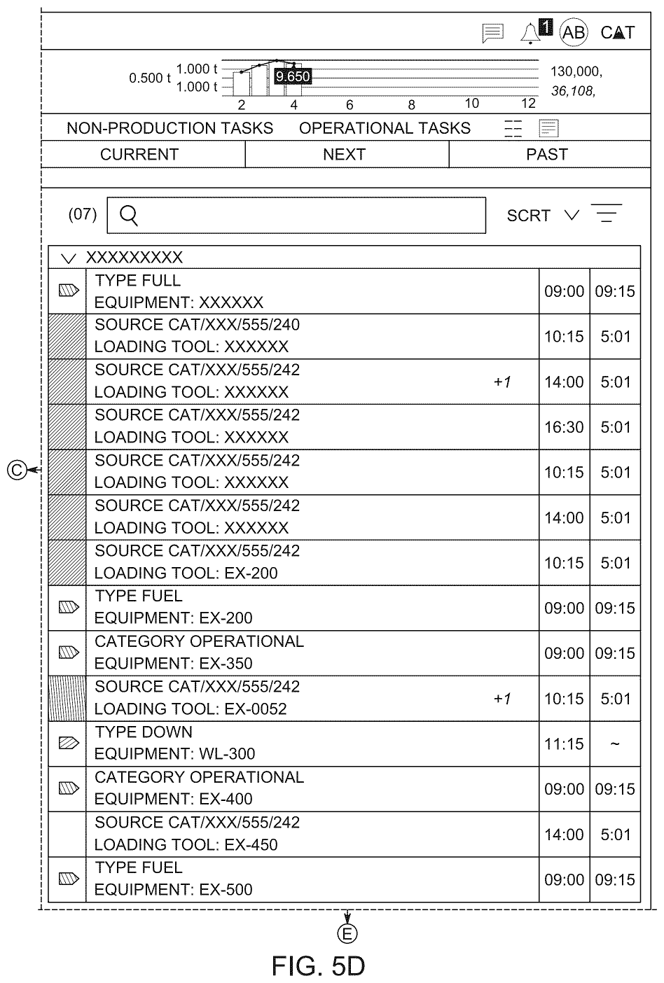

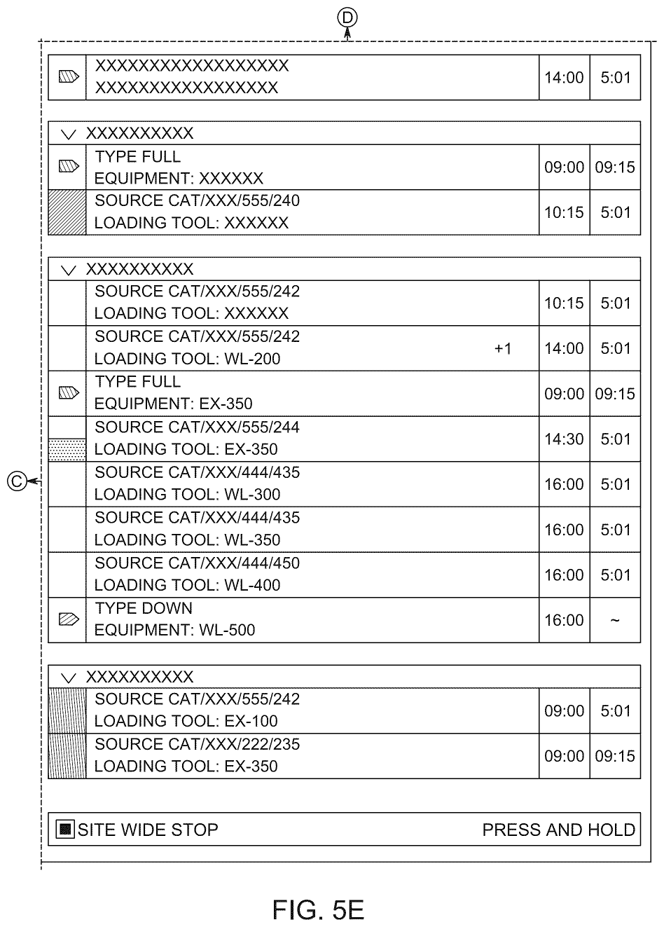

The controller 20 can track progress and compliance to outcomes, i.e., jobs, using the forecasting engine 28. Such progress and/or compliance can be output, for instance, on the operator control interface 31, e.g., a graphical user interface (GUI), of one or more displays of console 30, particularly the specialized management operator interface 330, such as shown in FIGS. 5A-5E.

Such progress and/or compliance may also be output, for instance, across the network 18 to another component of the mining management system 12, such as another controller 20, and/or to another separate mining management system 12. For instance, if a particular job indicates that a particular one of the hauling machines 50 is expected to travel to a workshop at a specific time for maintenance, the controller 20 can record the actual time that the hauling machine 50 traveled to the workshop, if different from the expected time, as a variance to the short-term plan.

As an example, the specialized management operator interface 330 may indicate that a problem exists such that the processing plant 48 is expected to drop to a production level below a certain amount. Input to the specialized management operator interface 330 can make adjustments (e.g., adjust an operational delay) to the production plan. Within a relatively short amount of time (e.g., 5-15 seconds), the specialized management operator interface 330 can update to see the result of the adjustment and to make further adjustments as needed.

As noted above, the specialized management operator interface 330 may be associated with the so-called forecasting or Forecaster, which is discussed in more detail immediately below, and which can introduce and implement short interval control (SIC). As an example, generally, the operator can have a cadence within the shift to check the Forecaster say every three hours, for instance. The operator can look for one or more of the following: validation issues; tasks are performing as required to plan for both time and tons to target; the impact operational and non-production tasks have on the production tasks, as these events will stop production during that time; and any gaps or overlapping tasks. Once issues are identified, the operator can click on the task and make necessary adjustments to that task via a manage panel, i.e., edit the tasks fields, add new tasks, close tasks, and/or call the planner or shift supervisor to provide necessary plan changes.

### Forecaster

Turning now specifically to forecasting, in the context of the present disclosure, forecasting can be regarded as involving incremental calculation of production rates and completion times for tasks, loading tools (e.g., digging machine 52), and processors (e.g., a crusher at processing plant 48). Calculations or determinations can be performed, for instance, by the controller 20, for individual work machines such that the forecasting performance can scale or be scaled proportionally to the changes made and not to the size of the mine site 10. For example, if a change is made that invalidates the forecasts for five (5) tasks, the forecasting can respond with updated forecasts in a defined, consistent time regardless of the size of the mine site 10, e.g., no matter how many machines are working at the mine site 10. The forecasting can predict future production rates for loading tools (e.g., digging machine 52) and processors (e.g., a crusher at processing plant 48) using one of two methods, the first pertaining to tasks that have not been started and the second pertaining to tasks that have been started. Thus, individual components of the forecast can be changed without having to redo the entire forecast. That is, the time required to complete updates to the forecasting can be proportional to the changes rather than instead being based on the time required to update the entire mine site.

Regarding tasks that have not been started, where no historical data is available, predictions for rates and end times can be determined based on machine capacity and planned start and end times. One purpose of these predictions can be to advise whether tasks as defined are viable, e.g., the work machine can achieve the defined target during the planned period. Regarding tasks that have been started, where tasks have been started and historical data is available, the historical data can be used to predict future rates and end times. Optionally, predictions based on historical data may be weighted to favor more recent historical data. Related operational tasks, i.e., delays, can be considered for both loading tools (e.g., digging machine 52) and processors (e.g., a crusher at processing plant 48) when making predictions. For example, an operational task, i.e., a delay, for a loading tool can be shown as a drop in production for any associated processors unless other loading tools are able to increase production to compensate. Future rates for processors may be predicted by rolling up the predicted rates for associated loading tools.

In operation, according to one or more embodiments of the present disclosure, the forecasting engine 28 can receive as inputs ‘Available’ and ‘Ready’ tasks. Such tasks can be handed off to the forecasting engine 28 which can use the tasks to produce a set of forecast rates. The forecasting engine 28 can also receive as inputs dynamic rates, travel times, and machine type. Thus, inputs can be or include loading tool and dump capacity (which may be dynamic), historical key performance indicators (KPIs,) i.e., work already performed by loading tool and dumps, historical task rates, e.g., average rates achieved by loading tools and dumps over the completed portion of the task, production arcs, i.e., current instantaneous rates for loading tools and dumps, and active assignments. More generally, the forecasting engine 28 may use only the ‘Ready’ and ‘Available’ tasks, production arcs, forecast rates, and basic mine model attributes for interaction via the specialized management operator interface 330. There may be no operator interaction required to start the Forecaster. This can be done automatically, that is, tasks simply may be in a state of ‘Ready’ or ‘Available’ to show up on the Forecaster.

The forecasting engine 28 can monitor the “last_updated_time” for each task and can incrementally update the related forecast rates as required. As noted above, the incremental update of forecast rates for tasks can improve the scalability of the solution, e.g., so that the performance of the forecasting is proportional to the size of the change rather than the size of the mine model, as noted above. Put another way, the forecasting engine 28 can update individual components of the forecast without redoing the entire forecast. Note that the forecasting engine 28 may not use the mine model state or truck payload state to calculate forecast rates. This is intentional, as there is an expectation that the mine model state will change when ready tasks are made ‘Available,’ e.g., may not meet all of the pre-requisites for a ‘Ready’ task.

In practice, ‘Ready’ and ‘Available’ tasks can be passed to the forecasting engine 28. The specialized management operator interface 330 may be used to pass the ‘Ready’ and ‘Available’ tasks to the forecasting engine 28. The controller 20 may determine whether historical data is available, for instance, received from the mine site 10 and/or from previous iterations of the forecasting. As noted above, inputs to the forecasting engine 28 can include loading tool and dump capacity (which may be dynamic), historical key performance indicators (KPIs), i.e., work already performed by loading tool and dumps, historical task rates, e.g., average rates achieved by loading tools and dumps over the completed portion of the task, production arcs, i.e., current instantaneous rates for loading tools and dumps, and active assignments.

If historical data is available, the forecasting engine 28 can calculate future rates and end times using the historical data. Here, the calculation may be for a blended rate using historical rates (e.g., 50%) and current (production arc) rates (e.g., 50%). Though the example given shows a 50/50 blend rate, the percentages may be configurable. A blended rate may be implemented, versus only historical or only current, because neither individual rate, alone, may be sufficient to produce suitable rate predictions in all situations. In the case of historical data being available, the historical data may be weighted to favor more recent historical data.

If historical data is not available, the forecasting engine 28 can calculate future rates and end times using, for instance, work machine capacity and planned start and end times.

In either case, the forecasting engine 28 can provide the prediction(s), which notably should (or must) reflect operational tasks, i.e., delays, for instance, for both the loading tool(s) and the processor(s). Outputs at this stage can be or include forecast task start and end times.

The foregoing processing by the forecasting engine 28 may involve saving the current time so that it may be used to set the ‘last updated’ times for any forecast rates updated during this execution of the forecasting engine 28. The processing may also involve, for all operational and non-production tasks in the short interval control (SIC) window that have been updated since the last run of the Forecaster, mark all related production tasks as recently updated (update their last updated time). The last update time for active production tasks may also be updated if a set amount of time has passed with no related activity, e.g., ten (10) minutes. For all incomplete production tasks that are in the SIC window where the update time for the task is greater than the update times for the related forecast rates, forecast the completion time for the task.

It is also noted that all calculations regarding historical key performance indicators (KPIs) and historical task rates can be calculated based on completed cycles, i.e., material tipped at dumps; work in progress, i.e., ‘Active’ assignments for loaded hauling machines, and travel times can be taken into consideration when calculating completion times and rates for loading tools; consideration may be for only those loading tools, sources and dumps that are marked as “used_in_assignment”; time related to operational and non-production tasks can be taken into consideration when forecasting completion times; available operating hours can be calculated over the forecast period; where no loading tool or dump targets have been set, the task target can be allocated out to the loading tools and dumps prorated by capacity and available operating hours, e.g., time; where a goal has been set, the goal can be allocated out to the loading tools and dumps prorated by capacity and available operating hours, e.g., time; work completed for loading tools, i.e., progress to task target, can be adjusted to compensate for active assignments, e.g., hauling machines that have been loaded but have not yet dumped, which can avoid over-running task targets for loading tools working long runs where there may be several loaded hauling machines following active assignments; and although the capacity of both loading tools and processors should be taken into consideration, the forecast task end time can be set to the time when the loading tools are expected to finish work on the task. Note that it would be expected that the task would be ‘Closed’ when all the associated loading tools have met their targets, even though hauling machines may still be travelling to dumps and dumps may still be active processing material even after the task has been ‘Closed.’

To the extent that the foregoing applies to use cases for tasks that involve both loading tools and dumps, it is also noted that to the extent the foregoing applies to a task involving only loading tools, the approach would remain the same except that all steps related to forecasting for dumps would be skipped. Likewise, where a task only includes dumps, the task end time can be set to the time when the dump is expected to finish processing material related to the task and all steps related to forecasting for loading tools would be skipped.

Referring again specifically to the processing by the forecasting engine 28, for all incomplete production tasks that overlap the short interval control (SIC) window where the update time for the task is greater than the update times for the related forecast rates, the forecast rates for each loading tool and processor can be updated. The approach taken here can be to forecast the production rates for the referenced loading tools first and then to use the forecast production rates calculated for the loading tools to set the production rates for the processors. The production rates calculated for the loading tools can be offset in time when applied to processors to account for travel times of the hauling machine(s), for instance. At this stage, inputs to the forecasting engine 28 can be or include forecast task start and end times, loading tool and dump capacity (which may be dynamic), historical KPIs, i.e., work already performed by loading tools and dumps, historical task rates, i.e., average rates achieved by loading tools and dumps over the completed portion of the task, production arcs, i.e., current instantaneous rates for loading tools and dumps, and active assignments. Outputs can be or include forecast rates for loading tools and dumps.

The forecasting engine 28 can then lock the forecast rate cache, remove any old forecast rates, and add the updated forecast rates for each updated production task. Forecast-related task KPIs can then be updated.

The total forecast rates for each loading tool and dump, e.g., at a processor, during each distinct time period can be checked. Where a loading tool or a processor is forecast to exceed its rated capacity, the forecasting engine 28 can find all production tasks related to the work machine that include the time period and mark them as having an invalid forecast. The above-referenced “forecast period” can be the configurable period whereby the forecasting engine 28 looks ahead of the current time. The forecast period can typically be between one (1) and three (3) hours, as an example.

The tasks can be checked to determine whether each is being performed to track. Here, the checking can involve looking for validation issues, whether tasks are performing as required now, as well as in the future, e.g., 3 hours ahead, and in the past, e.g., 3 hours behind, which can include forecasted production and time, what impacts operational tasks and non-production tasks may have on production, and gaps and overlaps in tasks. Such checking may be performed, at least in part, using the specialized management operator interface 330, such as shown in FIGS. 5A-5E. Any validation issues may be noted and corrected, as required. Here, task with issues can be shown, for instance, with an exclamation icon (!). The entirety of the issue can also be highlighted, for instance, in a specific color such as amber. The operator can click on the task itself or a task errors details section of the Forecaster, e.g., on the right side of the operator interface, to access more details on the issue(s). To correct the issue, the operator can interact with the entity to resolve the issue, if and as required.

Thus, the specialized management operator interface 330 can provide a timeline with a list of tasks generated from the mine plan. The timeline can be divided into a three-hour look-ahead and a three-hour look-back relative to a now or current timeline (e.g., vertical line in FIG. 5B). This can allow a twelve-hour shift to be broken into quarters to allow for easier management of operations through a short interval control (SIC) process. The specialized management operator interface 330 can provide for the dynamic management of historical and planned tasks over short interval control (SIC) windows toward the completion of tasks, rather than necessarily attempting to optimize mining operations by monitoring progress towards the completion of a static or fixed set of production goals. The specialized management operator interface 330 can, thus, show which production tasks have already been completed, which production tasks are ahead or behind schedule, when future production tasks will complete, only tasks in the SIC window, how operational tasks, i.e., planned delays, will impact production tasks, and/or plan periods where there are gaps or excess planned production, i.e., over capacity, as examples. An indication can be provided regarding the forecast completion time for each task. When operational and/or production tasks are changed, the specialized management operator interface 330 can provide near real-time feedback, e.g., within 5-10 seconds. As noted above, the operator clicking on the task can allow the operator to make changes.

### Spark Charts

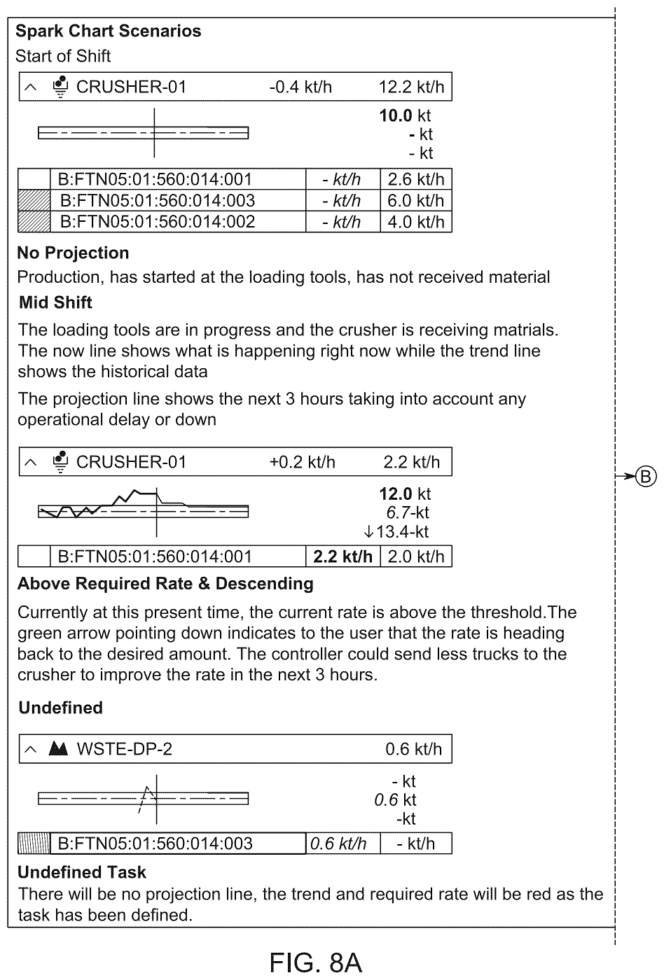

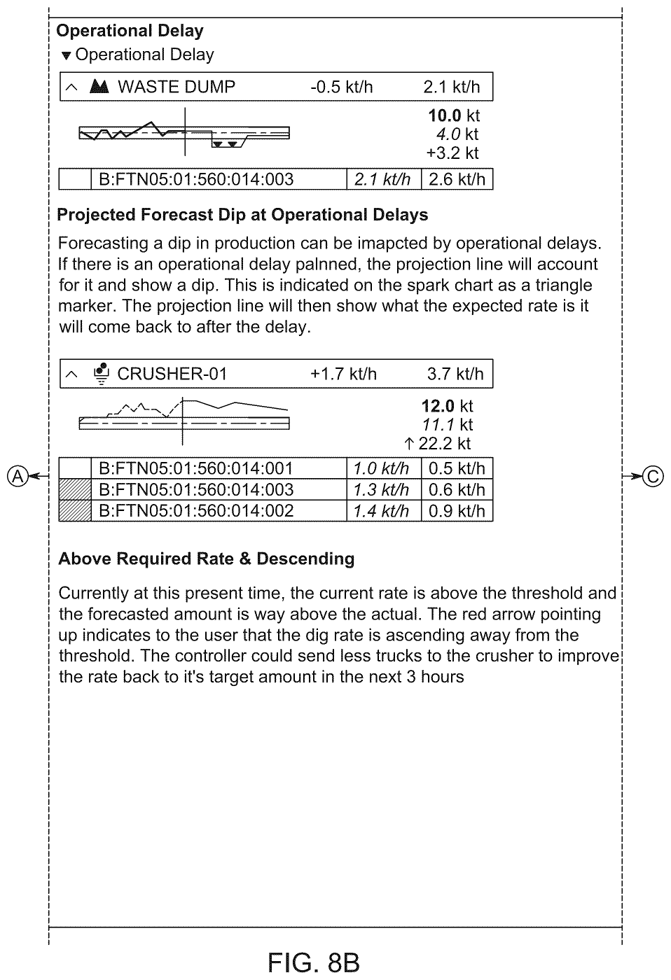

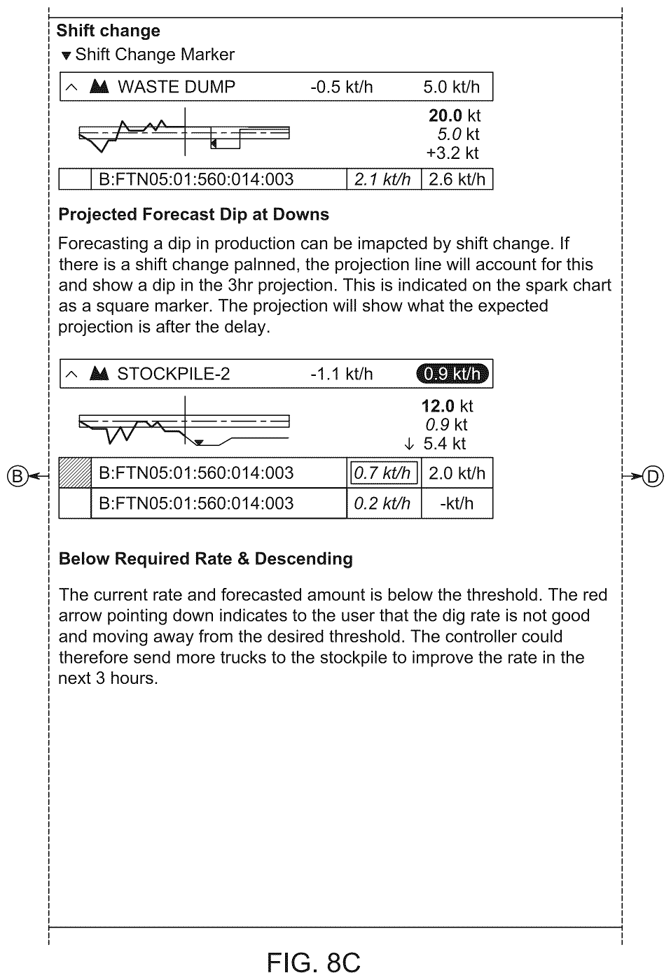

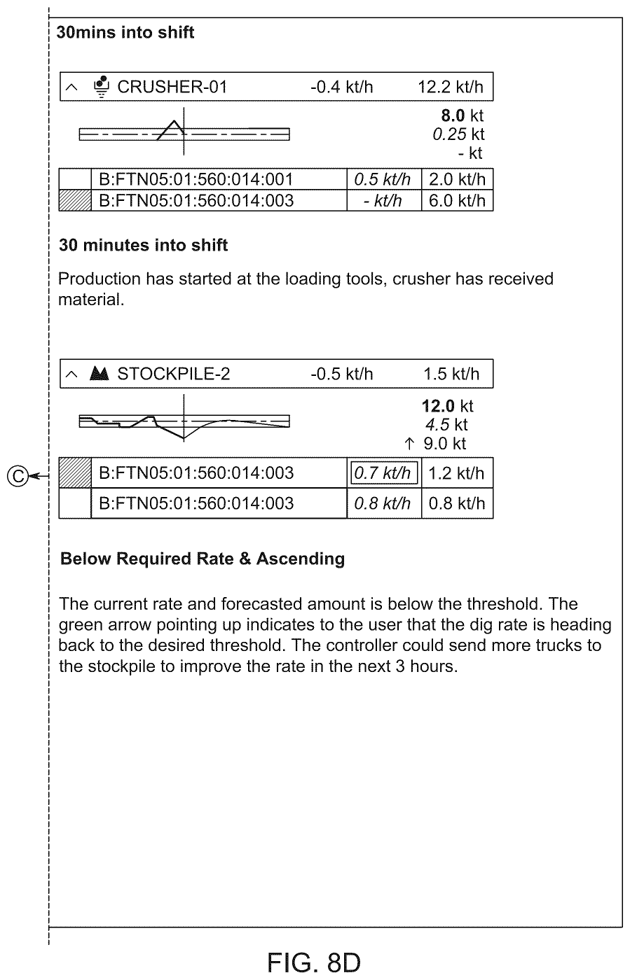

Predictions for rates and end time can be used to populate one or more Spark Charts, each of which may be referred to or characterized herein as a specialized short interval control (SIC) operator interface. FIG. 6A provides an example of a specialized SIC operator interface 350 according to one or more embodiments of the present disclosure. FIG. 6B provides annotations to select portions of a specialized SIC operator interface 350 based on that of FIG. 6A. Historical results may also be used to populate the specialized SIC operator interface 350. That is, the SIC operator interface 350 can be associated with the forecasting aspect and the active work aspect. FIGS. 8A-8D also show various scenarios for the specialized short interval control (SIC) operator interface according to one or more embodiments of the present disclosure.

As work is completed it may be recorded as a cycle. The cycles can become historical data indicating performance against the plan and/or tasks. The cycles may be compiled into progress statistics and Spark Charts (which as noted above may be referred to as specialized short interval control (SIC) operator interface(s)) to show actual performance in comparison to the tasks in the plan. Thus, specialized short interval control (SIC) operator interface(s) 350 may have a historical component as well as a forecast component.

Here, the specialized SIC operator interface 350 can show historical rates and forecast rates over a SIC window by individual task. Discontinuities at the current time may show potential issues with compliance to plan, e.g., historical rate is lower than forecast rate. The specialized SIC operator interface 350 may be used to show how production rates for loading tools and processors have trended historically and how they are expecting to trend into the future, e.g., for the remainder of the SIC window.

The specialized management operator interface 330 and the specialized SIC operator interface 350 can provide a relatively quick, high-performance tool to provide immediate feedback, e.g., within 10-15 seconds, as to what is currently going on at the mine site 10 and what is expected to happen over that SIC window, where such tool(s) can allow adjustments to the tasks as needed. Thus, the specialized management operator interface 330 and/or and the specialized SIC operator interface 350 may be used to see what mining has occurred against the plan and what changes may need to be made now to get the plan back on track. Hence, the specialized management operator interface 330 and the specialized SIC operator interface 350 can also allow assessment of current and planned compliance to plan.

Optionally, an artificial intelligence (AI) tool may be implemented to annotate the Spark Chart(s). Generally, the AI tool can analyze the data and provide recommendations, output on the Spark Charts, for instance, for how to improve production. For instance, a pop-up may be generated on the Spark Chart. As a specific example, based on the pop-up the operator could say at this time it looks like production is dropping, so extra capacity exists. The AI tool may recommend specific changes to the tasks to potentially make to increase overall production.

### Active Work

The active work engine 29 can output variations in the current state of the mine site 10 compared to the planned state of the mine site 10. In operation, the output(s) from the active work engine 29 can match cycles to ‘Available’ and ‘Ready’ tasks. Here, the cycles can be complete or in-progress. The active work engine 29 may also determine amount of material moved and historical rates for each task.

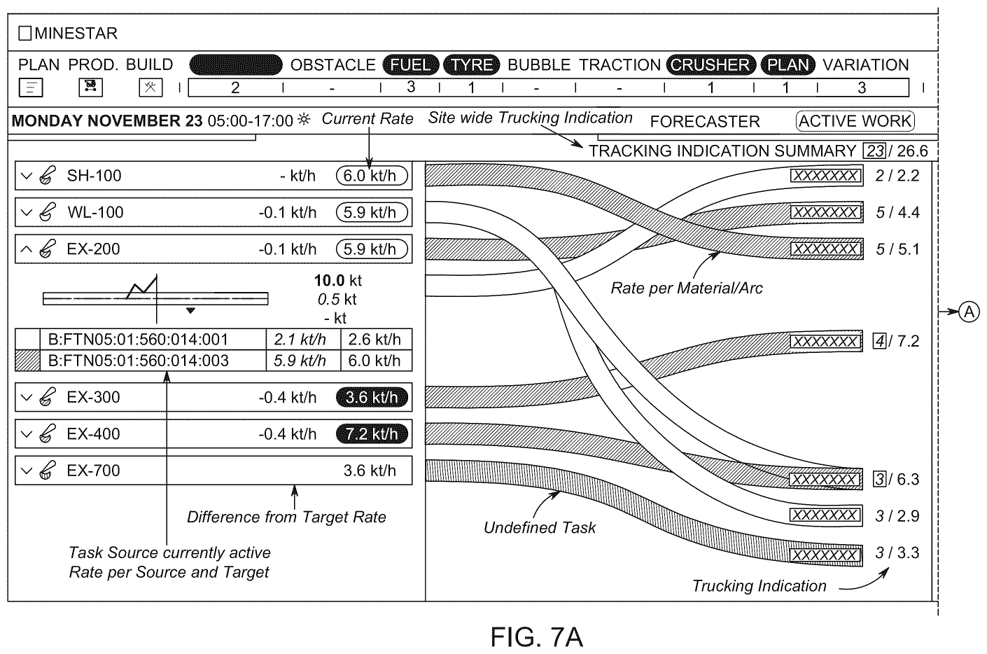

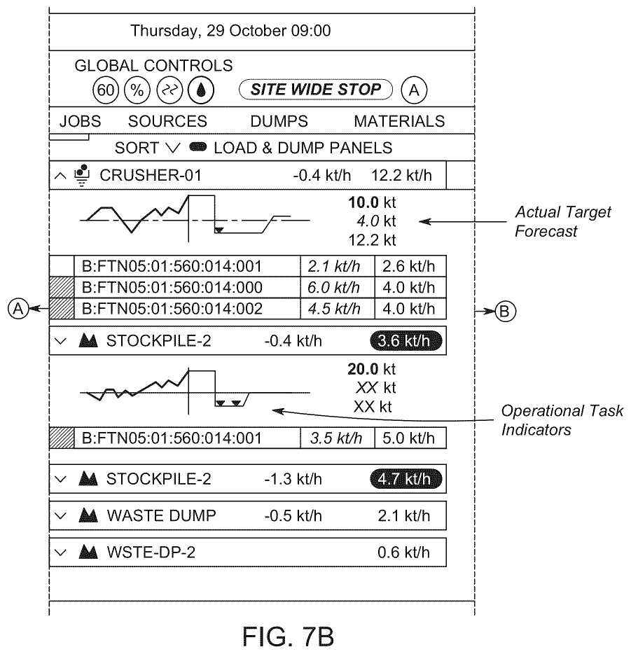

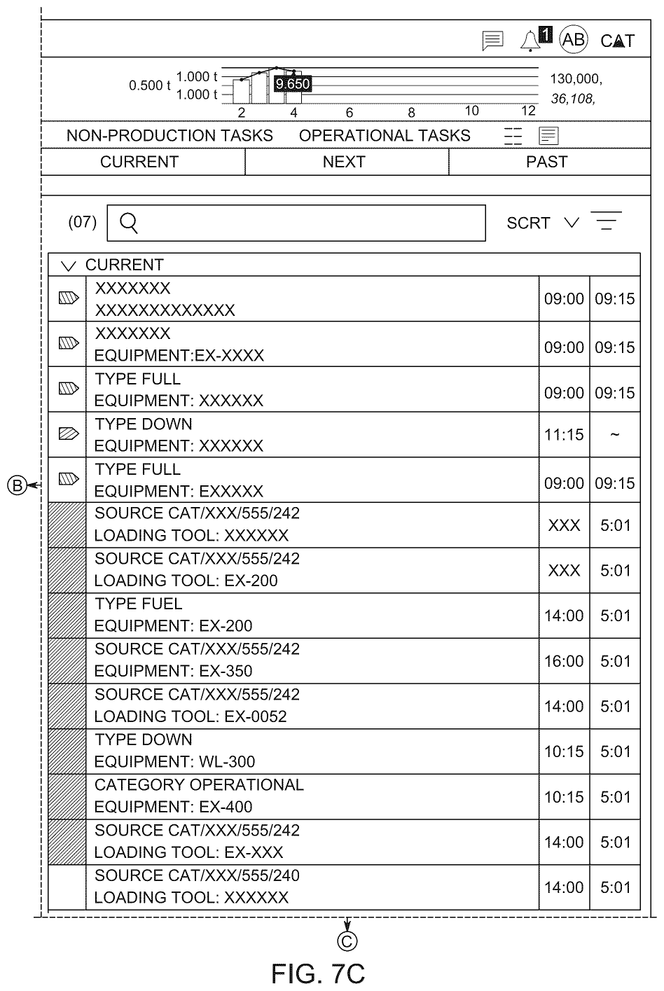

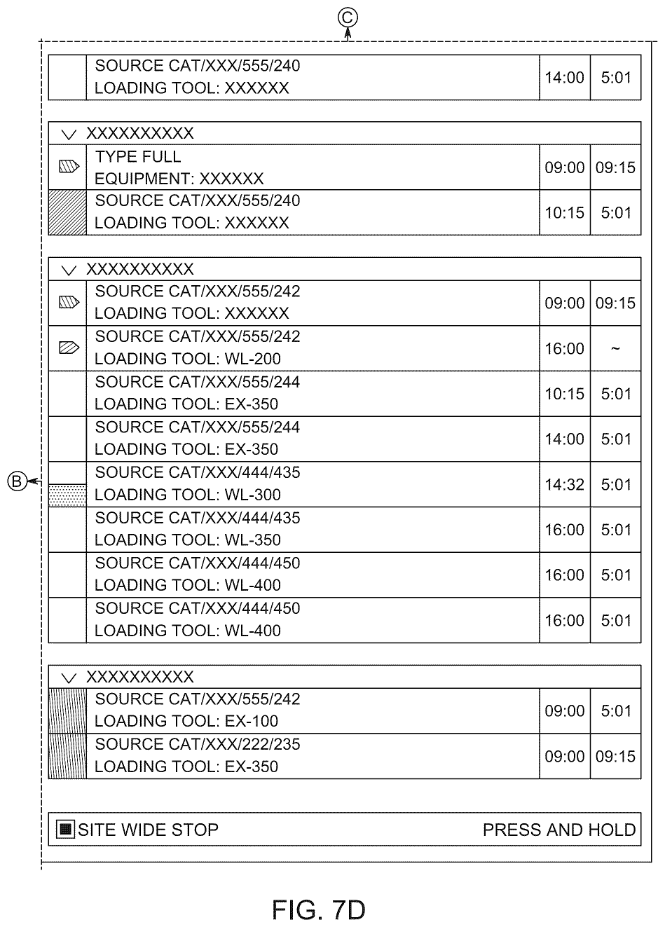

The output of the active work engine 29 can be provided on the operator interface 31, particularly the active work operator interface 370 thereof. FIGS. 7A-7D show an example of the active work operator interface 370 according to embodiments of the present disclosure. Here, the active work operator interface 370 can provide an active work interface for visually displaying variations in the current state of the mine site 110 as compared to the planned state of the mine site 10. The active work operator interface 370 can focus attention on the tasks that are currently being undertaken, i.e., tasks currently in the execution stage. The active work operator interface 370 can show real-time conformance to tasks and unplanned activities, since the system can receive data from the mine site 10 in real time. The active work operator interface 370 may also provide contextual focus to identify specific tasks that relate to a single entity such as a loading tool or a dump. The active work operator interface 370 can include material arcs and flow rates included in the currently active production plan as produced during initial assignment, such as shown in FIGS. 7A-7D. FIGS. 7A-7D include annotations to highlight select portions.

Incidentally regarding tasks, the operator control interface 31 can, at times, provide, use, and/or analyze various pieces of information or data regarding tasks. Such information or data may be output on the specialized analyzer operator interface 310, the specialized management operator interface 330, the specialized short interval control (SIC) operator interface 350, and/or the specialized active work operator interview 370.

For instance, from time-to-time, a notification can be generated for a task. This may be referred to or characterized as a task notification. For instance, if the forecasting produces forecast rates that are insufficient to complete a task on-time, a notification may be generated to inform a operator of this observation.

Task metadata information may be provided or implemented and may be or include information about tasks that may make tracking and working with a specific task easier. Task metadata may include: type—the task a production task, operational task, or a non-production task; and workflow—will that task follow the ‘Auto Task Workflow’ or the ‘Manual Task Workflow.

Task activity timeline can provide a limited time bounded view of entity specific activities related to the task. Each entry in the timeline can provide an update regarding a change to one of the following attributes, as examples: started—the current state of the started flag for the entity (loading tool, source, or processor); active—the current state of the active flag for the entity (loading tool, source, or processor); completed—the current state of the completed flag for the entity (loading tool, source, or processor); mining block ID—the ID for the mining block that is currently being worked by a loading tool, which may not be used for sources or processors; mining block name—the name, e.g., external reference, for the mining block that is currently worked by a loading tool, which may not be used for sources or processors; and operator—the operator currently associated with a loading tool. Note that the mining block that is currently being worked by a loading tool may not align to the plan (e.g., may not align to a source defined for the task). The task activity timeline can be used to display historical state information for machines and tasks in the specialized short interval control (SIC) operator interface 350.

A task KPI decorator can allow for KPIs to be stored as key-value pairs within the task for future reference. This decorator may include the following KPIs, as examples: total cumulative material moved for all associated forecast arcs; forecast cumulative material moved for all associated forecast arcs; current production rate for all associated forecast arcs; cumulative material moved for each loading tool for all associated forecast arcs; forecast cumulative material moved for each loading tool for all associated forecast arcs; current production rate for each loading tool for all associated forecast arcs; cumulative material moved for each processor for all associated forecast arcs; forecast cumulative material moved for each processor for all associated forecast arcs; and current production rate for each processor for all associated forecast arcs.

A task target decorator can define the cumulative production target for the task as defined in the plan. This target may be used to mark the task as ‘Completed,’ e.g., at least for ‘material move’ tasks. The task target can be used to determine when a production task is ‘Complete,’ to forecast completion times, and to set rates for assignment. The task target may be overridden by a task goal. The task target may be shown on the operator control interface 31 when showing metrics related to task completion, e.g., % complete.

A task goal decorator can record an override, e.g., operator override, of the task target. Operators may use the task goal to force a task to under-produce or over-produce as required to respond to unplanned circumstances. Where defined, task goal can override the task target and can be used to forecast completion times and to set rates for assignment.

A task delay decorator can contain all of the attributes required to fully define a ‘Delay’ type task. The task delay can be associated with operational tasks. Task delay may be used to automatically set an operational task or a referenced machine to ‘Active’ or ‘Completed.’ Operational tasks may be marked as ‘Completed’ automatically when all associated machines are marked as ‘Completed.’

A task scheduled assignment decorator can contain all of the attributes required to fully define a ‘Scheduled Assignment’ type task. The task scheduled assignment can be used to plan out a scheduled assignment for a hauling machine 50.

A task job decorator can associate tasks with one or more jobs. For example, consider a task that involves moving material from a specific mining block to a processor. This task might fit the criteria for a job that says to mine out the mining block by a certain time and another job that says to deliver a specific blend to the processor. The task job can associate a job with one or more tasks. Once a task has been associated with a job, the association may not be changed. Tasks may need to be cloned where they are to be applied/associated with a new plan/job.

A task machine class decorator can allow for one or more machine classes to be associated with a task.

A task loading tool decorator can allow for one or more loading tools to be associated with a task. Note that there may be no restrictions regarding how many active tasks might reference the same work machine. Multiple work machines may be associated with a single task for the following reasons, as examples: blend—to specify a group of loading tools that are required to work together to achieve a single blend; recipe—to specify a group of loading tools that are required to work together to achieve a single recipe; and operational outcome—to specify a group of loading tools that are to work together to achieve a specific operational outcome. The task loading tool decorator may have additional attributes which are to be used to better manage the work flows, such as some or all of the following: started—this can be a flag indicating that the loading tool has started working on the related task or completed some activity aligned to the task; active—this can be a flag indicating that recent activity has been observed for the loading tool related to this task; completed—this can be a flag indicating that the loading tool target associated with this loading tool has been achieved; loading tool target—this can be a percentage of the target or goal set for the task (it can be used to distribute the work flow for the task across the referenced loading tools, where, when no target is specified, the task work flow will be distributed evenly across the referenced loading tools, e.g., prorated by loading tool capacity; and mining block—this can be a reference to the mining block that the loading tool is expected to dig or load, which may not limit the mining blocks, i.e., sources, that the loading tool will actually dig as this will be based on the location and dig path for the Loading Tool; the reference to a mining block is meant as a hint that may be used for display prior to the commencement of work by the loading tool, e.g., to show which mining block the loading tool is expected to dig. The task loading tool decorator can be used to associate one or more loading tools with a production task. Machine specific targets may be set for loading tools. The status of the loading tool can also be tracked as ‘started,’ ‘active,’ and ‘completed,’ i.e., achieved target. Machine specific status information can be used to show machine states, for instance, on the specialized short interval control (SIC) operator interface 350.

A task AUX Machine decorator can allow for one or more auxiliary work machines to be associated with a task. Note that there may be no restrictions regarding how many ‘Available’ tasks might reference the same auxiliary work machine. Auxiliary work machines can be included in a separate decorator due to the number of loading tool specific attributes required (for target and mining block).

A task dump decorator can allow for one or more dumps to be associated with a task. Note that there may be no restrictions regarding how many active tasks might reference the same dumps. Multiple dumps may be associated with a single task for the following reasons, as examples: alternate—to specify an alternate processor that may be used in the event that the preferred processor is not available; overflow—to specify an alternative processor that may be used in the event that the capacity of the preferred processor is exceeded; blend—to specify a group of processors that are required to work together to achieve a single blend; recipe—to specify a group of processors that are required to work together to achieve a single recipe; operational outcome—to specify a group of processors that are to work together to achieve a specific operational outcome.

The task machine decorator may have additional attributes which can be used to better manage the workflow, such as dump target and dump maximum mass. Dump target can be regarded as a percentage of the target or goal set for the task; it can be used to distribute the workflow for the task across the referenced processors. Where no target is specified, the task workflow can be distributed evenly across the referenced processor(s), and which may be prorated by processor capacity. Dump maximum mass can be regarded as the maximum amount of material that is to be dumped at the processor as part of the task. It is expected that this attribute will only be defined for alternate processors. A unit and unit name can also be defined for the processor maximum mass. Once the processor maximum mass has been reached, no further material flows should be assigned to the processor.

A task material decorator can allow for one or more materials to be associated with a task. Where this decorator is defined, only material movements associated with the listed materials will be counted towards the task. Note that this material decorator can also allow for the exclusion of specific material modifiers.

A task source decorator can allow for one or more mining blocks to be associated with a Task. Where this decorator is defined, only material movements associated with the listed mine blocks will be counted towards the task.

### INDUSTRIAL APPLICABILITY

Generally speaking, embodiments of the present disclosure involve systems, methods, and computer-program products for dynamic task-based, short-term planning and management of a mine site.

Though examples herein largely pertain to tasks implemented by hauling machines 50, the present disclosure is not limited to tasks involving hauling machines 50 and may pertain to tasks involving different types of machines. For instance, a ranked list of watering tasks for water trucks can be created and such watering tasks can be sent to assignment to work out how to assign specific water trucks to best complete the watering tasks. Likewise, a similar approach can be applied to road grading, i.e., the ranked road grading tasks can be to grade specific roads, and the assignment can work out the order in which road graders should be assigned to complete these road grading tasks.

Regarding planning and management of the mine site, short-term plans are often communicated to mine sites and can be implemented, for instance, by coordinating machine operations and configuring a Fleet Management System (FMS) for execution of load and haul activities. Implementing a short-term plan may involve allocating operators to machines, scheduling breaks, moving loading tools, opening or closing dumps, allocating one or more hauling machines to one or more loading tools, and adding production restrictions such as blend requirements.

The mine site may have implemented a short interval Control (SIC) system that collects information from many different systems to support decision making. Where the SIC system identifies a plan variation, it may communicate instructions, e.g., corrections, to the controller, which may be part of the FMS system, or to the FMS system in a case where the controller is not part of the FMS system. FMS systems may attempt to optimize productivity based on the current state of the mine site. Hauling machines may be dispatched, where dispatch may attempt to achieve optimization based on a static set of production goals which must be changed by the controller or external SIC system from time-to-time to comply with the short-term plan.

However, such FMS systems may not be able to look ahead and dynamically adjust production goals to satisfy the objectives of a short-term plan using the principles of SIC. Hence, such systems may not be able to take a mine plan and automate the process of implementing fleet assignments based on a ranking and then using SIC to determine dispatch orders. Accordingly, one or more embodiments of the present disclosure can address such shortcomings. That is, one or more embodiments of the present disclosure are directed to a fleet assignment engine that can be provided with the short-term plan, create task rankings, and use short interval control (SIC) to automatically assign the tasks. More practically, embodiments of the present disclosure can identify what needs to be done during a shift, i.e., tasks, and manage task ranking, assignment, and dispatch of machines to perform the tasks not to a current point in time but instead over all of the work that needs to be done for the SIC window, e.g., three hours in advance. Put another way, embodiments of the present disclosure can look ahead to optimize performance of tasks to complete the particular portion of the plan as opposed to optimizing to a point in time set of production requirements.

Tasks can be progressed through a sequence of predefined states, for example, ‘New,’ ‘Ready,’ ‘Available,’ and ‘Closed.’ Tasks in the ‘Available’ state can be used to set dynamic production goals for assignment over the short interval control (SIC) window. Dispatch decisions can be made with the objective to finish as many tasks on-time as possible in rank order. Unlike traditional production goals, tasks may be considered within the context of one or more other tasks when optimizing production.

According to one or more embodiments of the present disclosure, production optimization, which may be relatively computationally complex, can be separated from forecasting, which may be relatively computationally simple, to provide immediate feedback regarding the impact of changes made to the plan and/or based on conditions at the mine site. Forecasting can be performed for each ‘Ready’ and ‘Available’ task in isolation using, for instance, loading tool and crusher capacity, planned start and end times and actuals, where available. The forecasting can support incremental updates to maintain relatively quick response times even for relatively large mine sites, i.e., the forecasting can be scalable. The forecasts for individual tasks can be rolled up into so-called Spark Charts, which can provide an immediate visual indication of task viability.

FMS systems also may not have a means to visualize the SIC process at a cadence relative for the controller, nor present the planned tasks with the actuals in a way which readily identifies risks to compliance to plan. The controller may need to quickly analyze the progress towards task completion and receive indications of upcoming risks for a plan not being achieved or overachieved before it occurs.

Thus, embodiments of the present disclosure may be regarded as a task management system, method, and computer program product that can automate the hand-off of short-term plans from a planning system to a Fleet Management System (FMS) so that production goals may be dynamically adjusted to optimize compliance with the short-term plan over a short interval control (SIC) window. Here, one or more short-term plans can be imported into the Fleet Management System (FMS) as immutable jobs which can be used to monitor compliance to plan and to create ranked tasks that may be added, edited, or deleted, for instance, using the controller 20, to adapt the plan to actual site circumstances to optimize production. Tasks can progress through a sequence of states, which may include ‘New,’ ‘Ready,’ ‘Available,’ and ‘Closed,’ as noted above, wherein, the tasks in the ‘Available’ state can be used to set dynamic production goals for assignment over the SIC window.

Generally, one or more embodiments can provide an automated way to create ranked tasks to be executed to a provided mine plan. A mine plan, e.g., a short-term plan, can be provided and which can include, for example, priorities, production targets, and/or operational delays. In one aspect the system can create ranked tasks automatically from jobs of the mine plan, then the tasks can be validated. The system can then implement a three-step process, which may be performed in any order, and to some extent in parallel, including an assignment feature, a forecasting feature, and an active work feature. The foregoing may occur on a loop to provide updates for the duration of the mine plan.

For the assignment feature, the system can pass ‘Available’ tasks that overlap the short interval control (SIC) window to an assignment, such as assignment engine 27. The assignment engine 27 can allocate machines, e.g., trucks to loading tools, seeking to complete as many tasks as possible in rank order, where machine allocations may vary over time where such variations can allow for more tasks to be completed on time, and where machine allocations may change dynamically to adapt to delays or other circumstances. Here, as noted earlier, the assignment feature can automatically set dynamic rates of the machines to better optimize compliance to plan over the SIC window.

For the forecasting feature, the system can, using a forecasting engine, such as forecasting engine 28, look at historical data, e.g., mine site-related data and/or machine-related data, and make predictions for operational tasks, for instance, for loading and processing. Predictions may be used to populate a Spark Chart, i.e., a specialized visualization tool, and forecast rates can be shown on a console, such as console 30. Such visualizations can be used to assess current and planned compliance to plan.

The forecasting feature can also provide a specialized forecasting interface, such as specialized management operator interface 330 and specialized short interval control (SIC) operator interface 350. The specialized management operator interface 330 can obtain a list of tasks and information associated with the tasks, e.g., information of the loading tool, source, dump location, and materials, from a production plan and display information associated with the completion of tasks, e.g., expected time of completion of tasks, impact of planned down times, and/or development activities on completion of tasks. The shown information may be used to analyze any losses during a time interval, identify upcoming risks, e.g., planned down times and/or development activities, and implement changes in the production plan in a next time interval.

At least the combination of the smart assignment feature, which seeks to optimize compliance to a plan over time (and not just compliance to static rates), together with the forecasting feature, which can provide near real time feedback, for instance, on the console 30 regarding task progress, can improve both operator productivity and compliance to plan. Improved compliance to plan can reduce accumulated variance to plan and reduce the need for adjustments to the next planning cycle.

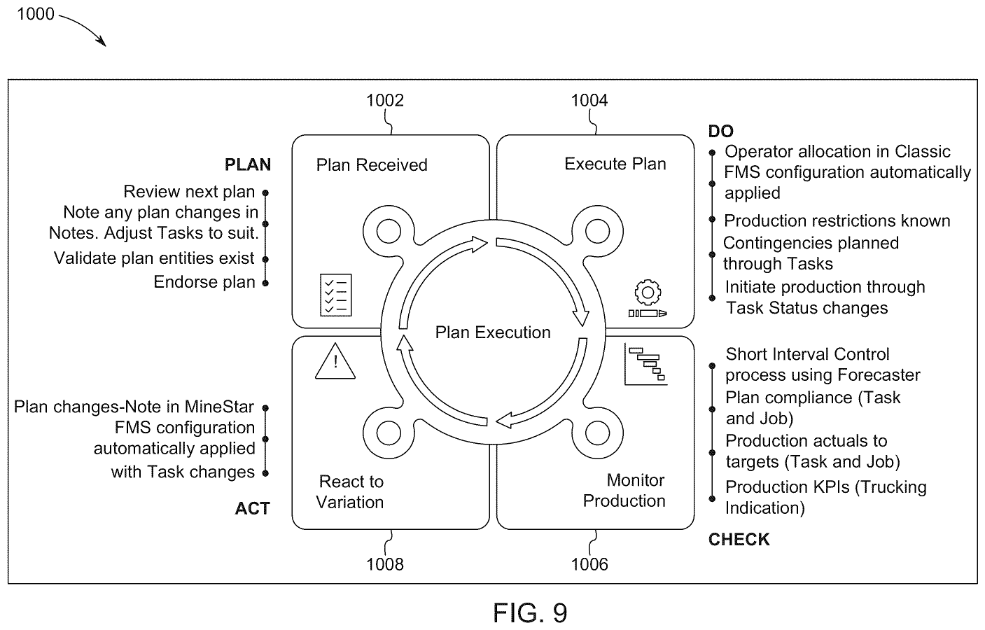

FIG. 9 is a basic flow chart of a method 1000 according to one or more embodiments of the present disclosure. Some or all of the method 1000 can be performed via a non-transitory computer-readable storage medium, or media, having stored thereon instructions that, when executed by one or more processors, such as processor(s) of controller 20, for instance, causes the one or more processors to perform some or all of the method 1000. According to one or more embodiments, the method 1000 may be regarded as a method for task management of a mine site and/or a method for task-based short-term planning and management of a mine site. When loaded with instructions, the controller 20, for instance, particularly one or more processors thereof, can be transformed into a specific-purpose processor and hence a specific-purpose controller 20 for the specific and practical application of task-based short-term planning and/or management of the mine site 10.

Generally, the method 1000 can involve a planning phase 1002, an execution phase 1004, a monitoring phase 1006, and a reaction phase 1008. In the context of the present disclosure, the method 1000 can be performed relative to a predetermined time period, for instance, an upcoming work shift or series of work shifts. Such predetermined time period may be regarded as a short-term interval. The method 1000, or select portions thereof, can be repeated in one or more loops, as noted above.

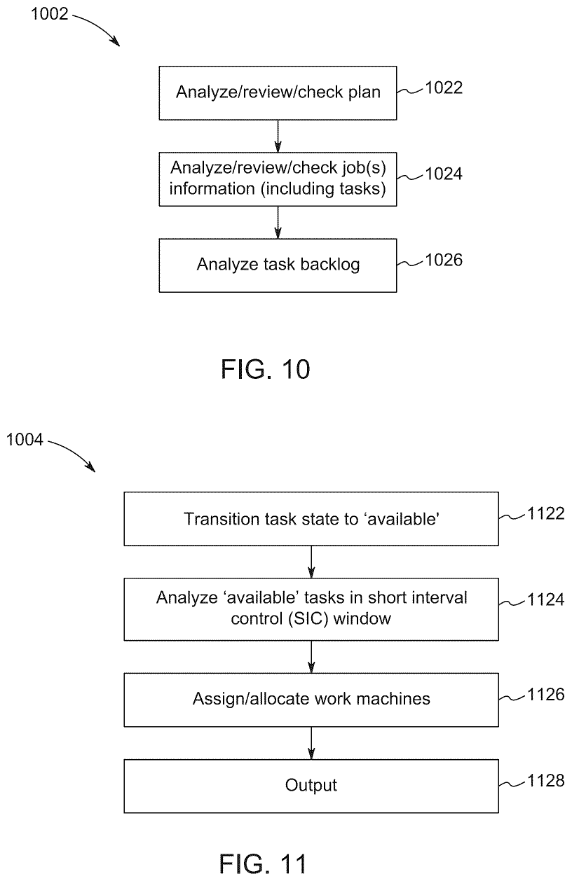

FIG. 10 shows more details regarding the planning phase 1002 based on the importation of one or more short-term plans for the mine site 10. Optionally, the one or more short-term plans can be selected for importation using the controller 20, for instance. Each short-term plan can be comprised of a set of jobs to be accomplished at the mine site 10. A plan, as noted earlier, can mean or be characterized as a unit of work that is submitted or imported from a planning system to controller 20, for instance, via network 18, but not necessarily through central station 54. Thus, the controller 20 may be referred to or characterized as a Fleet Management System (FMS). The short-term plan, or plans, can be electronically imported into computer-readable memory of the controller 20 and accessed using the console 30, for instance, via the operator control interface 31.

As noted earlier, jobs can describe material to be moved from a source to a dump, from a source alone, or to a dump alone. The outcome the job is looking to achieve can be generally pit progression or site product conformance to meet short-term plan objectives. Jobs can be imported as part of plans but may not be able to be added, removed, and/or changed by the controller 20. Each job can have a defined start time and a define end time, where both can be aligned to the related short-term plan.

At operation 1022, the details of the selected short-term plan (or plans) can be analyzed and understood, e.g., the required machine moves at the mine site 10, along with any comments pertaining to the plan and/or plan movements. The details of the short-term plan, and any comments and/or plan movements, can be reviewed, for instance, using the controller 20. Further, such details, and any comments and/or plan movements, can be reviewed using and the operator control interface 31, particularly the specialized analyzing operator interface 310 of the operator control interface 31. As a practical matter, and as a practical application, an upcoming short-term plan, or plans, can be imported and checked, using the controller 20 and the specialized analyzing operator interface 310 of the operator control interface 31 prior to an upcoming shift. Operation 1022 can also involve configuring production requirements, e.g., goals, priorities, blends, scheduled assignments and/or delays, configuring loading tools and dumps, e.g., based on validation shown, adding or adjusting planned tasks, and allocating or monitoring operator allocation to equipment.

At operation 1024, the specialized analyzing operator interface 310 can be used to access one or more jobs views of the specialized reviewing operator interface. As noted earlier, FIGS. 3A-3C show an example of specialized analyzing operator interface 310 according to embodiments of the present disclosure. According to one or more embodiments, the jobs and production tasks can be analyzed, for instance, using the controller 20, in conjunction with the operator control interface 31, including the specialized analyzing operator interface 310 thereof, to ensure that production can be executed. Additionally, non-production and operational tasks may be analyzed using the controller 20, in conjunction with the operator control interface 31, including the specialized analyzing operator interface 310 thereof.

At 1026, the specialized analyzing operator interface 310 can be used to access backlogged tasks, if any. This may involve determining whether each backlogged task is still required for the upcoming shift. The task backlog view of the specialized reviewing operator interface can show all tasks, including any ‘Closed’ tasks, for instance, sorted by plan or shift, if no plan available. FIGS. 4A-4C show an example of the specialized analyzing operator interface 310 providing a Task Backlog feature, view, page, or tab 326. As noted earlier, the specialized analyzing operator interface 310 portion of FIGS. 4A-4C can be accessed from the specialized analyzing operator interface 310 portion of FIGS. 3A-3C. Here, generally, the Task Backlog feature 326 can provide access to analyze whether tasks on backlog are still required for a particular shift, e.g., the current or next shift.

Referring still to the process of FIG. 10, the method 1002 can automatically create ranked tasks, in light of the job or jobs of the imported short-term plan, and by way of the controller 20, from the job or jobs of the short-term plan. The specialized analyzing operator interface 310 can be used to access the ranked tasks. Thus, the controller 20 can create a set of tasks in compliance with the plan, particularly where the tasks can be tasks that may need to be worked over a particular period of time to accomplish the particular job. Here, the initial tasks can be derived from the short-term plan itself. The short-term plan can include, or be viewed as sending, jobs, from which the system can then create production tasks. One or more of the ranked tasks can be modified, for instance, using the controller 20.

Here, the automatically created initial ranked tasks can be ranked according to a predefined relative priority, i.e., no absolute priority. The tasks can thus be provided in an ordered list, where the first task on the list is the most important, the second task on the list is the second-most important tasks, and so on down the list. The automatically created initial ranked tasks may be referred to or characterized as ‘New’ tasks. As noted above, a task in the ‘New’ state can mean that the task is not yet complete for application to production.

One or more additional new tasks can be created using the controller 20 as required, for instance, for any work not already included. According to one or more embodiments, such one or more new tasks may be referred to or characterized as ‘New’ tasks, as defined herein. Such ‘New’ tasks, whether initially automatically ranked or newly created, can be validated using the controller 20. For any tasks coming back invalid, such tasks can be modified and re-validated.

All validated tasks may then be prioritized, using the controller 20, as ‘Ready’ tasks. As noted earlier, ‘Ready’ state can mean that the task is complete and ready for production use but has not yet been released to production. According to one or more embodiments, the ‘Ready’ state may be used with automatic tasks only. Regarding automatic tasks, automatic tasks in the ‘Ready” state are available for activation and can be considered by the Forecaster, at least until they are marked as ‘Complete’, and automatic tasks in the ‘Available’ state the system can actively work to complete ‘Available’ tasks on schedule. Regarding manual tasks, manual tasks in the ‘Available’ state can be selected using the specialized analyzing operator interface 310 portion.

Some or all of the validated tasks that are approved for production can be selected using the controller 20. This can mean that the status of each task is transformed to ‘Available.’ As noted earlier, the ‘Available’ state can mean that a task is complete and ready for production. In the case of automatic tasks, the task has been released for automatic scheduling and execution using the controller 20. And in the case of manual tasks, the task is available for selection, i.e., activation, for instance, using the controller 20.

Referring again to FIG. 9, the method 1000 may then segue to implementing a three-step process, which may be performed in any order and to some extent in parallel, e.g., running in background, including the assignment feature, the forecasting feature, and the active work feature. Generally, the forecaster feature and the active work feature can be referred to or characterized as operations of analyzing progress to plan whereby, among other indications, indications of non-compliance may be identified and indicated. As noted above, the processing of the assignment feature may be relatively more complex and can be separated from the processing of the forecasting feature, which may be relatively less complex. For instance, the forecasting feature may only use tasks, forecast arcs, and basic mine model attributes for interaction using the specialized management operator interface 330.

First, the execution phase 1004 will be discussed. The execution phase 1004 can be or include the assignment feature, for instance, performed by the assignment engine 27. As noted above, assignment, in the context of the present disclosure, can mean or be characterized as a process by which a specific person or machine is directed to perform a particular task. Also noted above, assignment, in the context of the present disclosure, can optimize the allocation of hauling machines 50 to best achieve a production plan. Rather than assignment being configured to achieve static production rates over a period of time, where when circumstances change, the production static production rates would need to be adjusted to match the changes circumstances, assignment, according to embodiments of the present disclosure, can involve consideration of all Available tasks defined over a short interval control (SIC) window. Accordingly, with better visibility to both current and planned tasks, the assignment may dynamically adjust production rates, i.e., the allocation of hauling machine(s) 50 to digging machine(s) 52, to allow for the maximum number of Available tasks to be completed on time. Extending assignment to support dynamic production rates can reduce the requirement for constant monitoring and adjustment of static rates and can improve compliance to plan over the SIC window. FIG. 11 shows exemplary operations of method 1004.

At operation 1122, the method 1004 can selectively transition ranked tasks from the ‘Ready’ state to the ‘Available’ state when the tasks are ready to be executed. Prior to the ‘Ready’ state the tasks may have been in the ‘New’ state. Here, such tasks in the ‘Available’ state can include production tasks. Optionally, such tasks in the ‘Available’ state may also include operational tasks. The transitioning may be performed using the operator control interface 31, particularly, the specialized management operator interface 330 thereof, under control of the controller 20. Optionally, operation 1122 can confirm validation and check for errors, for instance, using the controller 20.

At operation 1124, the method 1004 can consider all ‘Available’ tasks defined over a short interval control (SIC) window. More specifically, the ‘Available’ tasks that overlap the SIC window can be determined, for instance, using the controller 20, and passed to assignment. ‘Available’ tasks not within the SIC window may not be considered. At operation 1124, other inputs can be passed to the assignment engine 27, such as input data, e.g., mine plan or plans, mine site data (e.g., received in real time and/or historical), machine-related data (e.g., status data or telemetry data received in real time and/or historical), and/or operator-related data.

At operation 1126, the method 1004 can assign work machines. More specifically, the method 1004 can assign or allocate hauling machines 50 (e.g., hauling trucks) to loading tools, such as digging machines 52. That is, operation 1126 can use the overlapping tasks to produce a production plan and assign hauling machines 50 to one or more of the loading tools. Such assignment, which can be performed by the assignment engine 27, can involve the setting of dynamic production rates for the machines. In this regard, the assignment engine 27 can assign the hauling machines 50 to loading tools seeking to complete as many tasks as possible on time in rank order. Hence, in some respects operation 1126 may be referred to or characterized as assigning machines to tasks. Here, the assignment engine 27 may vary hauling machine 50 allocations where such variations allow for more tasks to be completed on time. Thus, according to embodiments of the present disclosure, hauling machine 50 allocations may change dynamically to adapt to changing circumstances, e.g., planned delays. Further, work machine (e.g., hauling machine 50) allocations may vary over time where such variations allow for more tasks to be completed on time. Thus, work machine (e.g., hauling machine 50) allocations may change dynamically to adapt to changing circumstances, e.g., planned delays.

At operation 1128, the method 1004 can output indicia showing assignment-related data resulting from the operation 1126. The indicia may be output on the operator control interface 31, particularly on the specialized management operator interface 330 thereof. The operator control interface 31 can thus provide responsive feedback regarding the feasibility of all ‘Available’ tasks taking into consideration, for instance, the current state of the mine model, assignment groups, locks and bars, and hauling machine 50 availability/distribution.

Operation 1128 may also involve outputting signaling, for instance using the controller 20, to the mine site 10 to provide instructions or commands for the assignment of the work machines and also for the assigned machines to perform the tasks at the appropriate time and at the appropriate rates. Such signaling may be to the central station 54 and/or the hauling machines 50 and digging machine 52, either directly or indirectly through the central station 54.

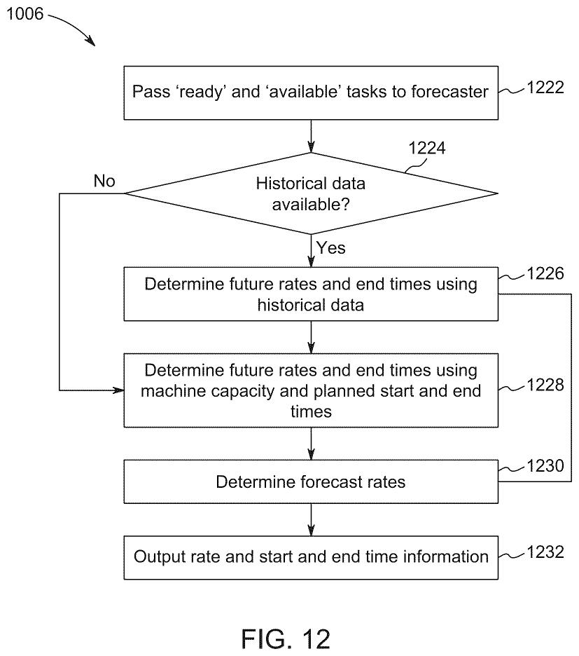

Referring again to FIG. 9, the monitoring 1006 can include forecasting and/or active viewing. Referring now to FIG. 12, this figure shows monitoring 1006 in the form of forecasting, for instance, using the forecasting engine 28 and the specialized management operator interface 330 and the specialized short interval control (SIC) operator interface 350. The forecasting associated with FIG. 12 can be used to visualize historical and planned tasks so tasks may be dynamically adjusted to ensure or optimize compliance to plan.

At operation 1222, the method can involve passing ‘Ready’ and ‘Available’ tasks as inputs to the forecasting engine 28. The forecasting engine 28 can also receive as inputs dynamic rates, travel times, and machine type. Thus, inputs can be or include loading tool and dump capacity, which may be dynamic, historical key performance indicators (KPIs), i.e., work already performed by loading tool and dumps, historical task rates, e.g., average rates achieved by loading tools and dumps over the completed portion of the task, production arcs, i.e., current instantaneous rates for loading tools and dumps, and active assignments. The specialized management operator interface 330 may be used to pass the ‘Ready’ and ‘Available’ tasks to the forecasting engine 28.

At operation 1224, the method, using the controller 20, for instance, can determine whether historical data is available, for instance, received from the mine site 10 and/or from previous iterations, for instance, of the forecasting. As noted above, inputs to the forecasting engine 28 can include loading tool and dump capacity, which may be dynamic, historical key performance indicators (KPIs), i.e., work already performed by loading tool and dumps, historical task rates, e.g., average rates achieved by loading tools and dumps over the completed portion of the task, production arcs, i.e., current instantaneous rates for loading tools and dumps, and active assignments.

If historical data is available (‘Yes’ at 1124), the method, at operation 1226, can calculate future rates and end times using the historical data. Here, the calculation may be for a blended rate using historical rates (e.g., 50%) and current (production arc) rates (e.g., 50%). In the case of historical data being available, the historical data may be weighted to favor more recent historical data.

If historical data is not available, the method, at operation 1228, the method can calculate future rates and end times using, for instance, work machine capacity and planned start and end times.

In either case, the predictions notably should, or must, reflect operational tasks, i.e., delays, for instance, for both loading tools and processors. Outputs at this stage can be or include forecast task start and end times. Of course, to the extent that the foregoing applies to use cases for tasks that involve both loading tools and dumps, it is also noted that to the extent the foregoing applies to a task involving only loading tools, the approach would remain the same except that all steps related to forecasting for dumps would be skipped. Likewise, where a task only includes dumps, the task end time can be set to the time when the dump is expected to finish processing material related to the task and all steps related to forecasting for loading tools would be skipped.

At operation 1230, for all incomplete production tasks that overlap the short interval control (SIC) window where the update time for the task is greater than the update times for the related forecast rates, the forecast rates for each loading tool and processor can be updated. The approach taken here can be to forecast the production rates for the referenced loading tools first and then to use the forecast production rates calculated for the loading tools to set the production rates for the processors. The production rates calculated for the loading tools can be offset in time when applied to processors to account for travel times (hauling machines). At this stage, inputs to the forecasting engine 28 can be or include forecast task start and end times, loading tool and dump capacity, which may be dynamic, historical KPIs, i.e., work already performed by loading tools and dumps, historical task rates, i.e., average rates achieved by loading tools and dumps over the completed portion of the task, production arcs, i.e., current instantaneous rates for loading tools and dumps, and active assignments. Outputs can be or include forecast rates for loading tools and dumps. However, the forecast rates may not be linked to hauling capacity. That is, the forecasting engine 28 can ignore haul capacity constraints. Here, an underlying assumption can be that the plan and the associated tasks are reasonably well sized to match the available trucking capacity, so it can be assumed that there is enough trucking capacity to cover the short-term plan. Incidentally, objectives (e.g., primary objective) of the Forecaster can be to show the operator where it is no longer possible to complete the planned work with the available equipment (e.g., the assigned loading tool cannot dig fast enough to get the work done on schedule), to see cases where the short-term plan is out-of-balance with equipment capacity (e.g., we have defined three tasks for a loading tool that would collectively require that it work three times faster than its rated capacity), and/or to indicate that the short-term plan includes periods where a crusher may be idle (e.g., all the loading tools feeding a crusher are scheduled to be down for maintenance at the same time). In this regard, the Forecaster can show substantial issues that are material to the achievement of the short-term plan, rather than relatively small inconsistencies in flow rates or trucking capacity.

At operation 1232, the rates and start and end time information can be output on operator control interface 31, particularly the specialized management operator interface 330 and/or the specialized short interval control (SIC) operator interface 350, which, as noted above, may be referred to as Spark Chart(s). The specialized management operator interface 330 and/or the specialized SIC operator interface 350 can be used to check the determined outputs.

In particular, the total forecast rates for each loading tool and dump (processor) during each distinct time period can be checked. Where a loading tool or processor is forecast to exceed its rated capacity, the forecasting engine 28 can find all production tasks related to the work machine that include the time period and mark them as having an invalid forecast. The “forecast period” can be the configurable period whereby the forecasting engine 28 looks ahead of the current time. As noted earlier, the forecast period can be between one (1) and three (3) hours, as an example.

The tasks can be checked to determine whether each is being performed to track. Here, the checking can involve looking for validation issues, whether tasks are performing as required now, as well as in the future, e.g., 3 hours ahead, and in the past, e.g., 3 hours behind, which can include forecasted production and time, what impacts operational tasks and non-production tasks may have on production, and gaps and overlaps in tasks. Any validation issues may be noted and corrected, as required.

Thus, the specialized management operator interface 330 can provide a timeline with a list of tasks generated from the mine plan. The timeline can be divided into a three-hour look-ahead, a three-hour look-back with a now or current timeline (vertical line in FIG. 5B). This can allow a twelve-hour shift to be broken into quarters to allow for easier management of operations through a short interval control (SIC) process. The specialized management operator interface 330 can provide for the dynamic management of historical and planned tasks over short interval control (SIC) windows toward the completion of tasks, rather than necessarily attempting to optimize mining operations by monitoring progress towards the completion of a static (fixed) set of production goals. The specialized management operator interface 330 can thus show, as examples, which production tasks have already been completed, which production tasks are ahead or behind schedule, when future production tasks will complete, only tasks in the SIC window, how operational task, i.e., planned delays, will impact production tasks, and/or plan periods where there are gaps or excess planned production, i.e., over capacity. An indication can be provided regarding the forecast completion time for each task. When operational and/or production tasks are changed, the specialized management operator interface 330 can provide near real-time feedback, e.g., within 5-10 seconds. That is, the specialized management operator interface 330 can be used to review individual task forecasts and the specialized short interval control (SIC) operator interface 350 can be used to assess current and planned compliance to plan. Put more generally, the specialized management operator interface 330 can predict when tasks, in-progress or soon-to-start, will be completed and in the case of soon-to-start tasks an estimate of when the task will start and how long it will take to complete, in addition to the predicted completion time.

The active work engine 29 can output variations in the current state of the mine site 10 compared to the planned state of the mine site 10. In operation, the output(s) from the active work engine 29 can match cycles to ‘Available’ and ‘Ready’ tasks. Here, the cycles can be complete or in-progress. The active work engine 29 may also determine amount of material moved and historical rates for each task.

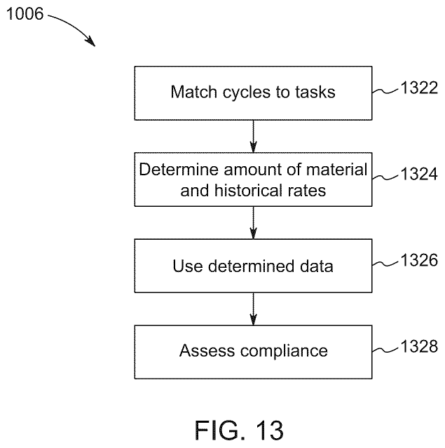

Referring again to FIG. 9, as noted above, the monitoring 1006 can include active viewing. Referring now to FIG. 13, this figure shows monitoring 1006 in the form of active work viewing, for instance, using the active work engine 29 and the specialized active work operator interface 370. The processing associated with FIG. 13 can be used to identify, in real time, conformance to tasks and unplanned activities. The specialized active work operator interface 370 can also provide a contextual focus to readily see specific tasks that relate to a single entity such as a loading tool or a dump.

In operation, the method 1006 show in FIG. 13 can include, at operation 1322, matching cycles to ‘Available’ and ‘Ready’ tasks, where the cycles can be complete or in-progress. Next, at operation 1324, the method can include determining amount of material moved and historical rates for each task. The historical rates may be used to populate Spark Charts for loading tools and processors, at operation 1326. At operation 1328 the method can involve reviewing individual Spark Charts to assess current compliance to plan.

Referring again to FIG. 9, the reaction phase 1008, which may be referred to or characterized as reacting to variation, can include, generally, adjusting or adding tasks and checking validation. Here, tasks may be selected from any view, i.e., the specialized analyzer operator interface 310, the specialized management operator interface 330, the specialized short interval control (SIC) operator interface 350, or the specialized active work operator interface 370, and adjusted as required. Here, adjustment can mean editing of one or more fields for the task. As an example, the operator can click on a task, e.g., from any view, to produce a manage panel view for the operator to make adjustment, changes, or edits to any of the fields for that task.

Afterward, an operation to reconcile and review one or more past plans can be performed. Here, reasons for variations can be noted. This can be done by selecting tasks from any view, i.e., the specialized analyzer operator interface 310, the specialized management operator interface 330, the specialized SIC operator interface 350, or the specialized active work operator interface 370.

Embodiments of the disclosed subject matter can also be as set forth according to the following parentheticals.

(1) An assignment engine system to perform managing operations according to task-based short-term planning comprising: planning circuitry configured to electronically provide a short-term plan for a mine site to be managed, the short-term plan defining at least an amount of material to be moved at the mine site; and processing circuitry operative as a fleet management system (FMS) and configured to electronically import, from the planning circuitry, the short-term plan as a set of immutable jobs into memory of the processing circuitry, electronically receive data associated with the mine site, the data including mine site-related data and machine-related data regarding a plurality of haul trucks and one or more loaders for the mine site, electronically automatically create ranked tasks from and for the immutable jobs to be performed by at least the haul trucks based on the mine-site related data and the machine-related data, selectively transition, using a specialized operator graphical user interface in coordination with the processing circuitry, the tasks from a ‘Ready’ state to an ‘Available’ state, electronically identify a short interval control (SIC) window associated with the short-term plan, the SIC window being shorter in time than the short-term plan, determine which of the tasks in the ‘Available’ state overlap the SIC window in time, electronically select, from among all of the tasks in the ‘Available’ state, only the tasks in the ‘Available’ state that overlap the SIC window in time, automatically electronically assign the haul trucks to the selected tasks over the SIC window based on the task ranking and such that as many of the selected tasks are to be finished as possible in order of the task ranking within a predefined time period, and electronically output, on the specialized operator graphical user interface, indicia showing the assignment of the haul trucks to the selected tasks over the SIC window.

(2) The assignment engine system according to (1), wherein the processing circuitry outputs signaling to provide instructions and/or commands to the haul trucks and the one or more loaders to perform the assigned tasks according to the task ranking.

(3) The assignment engine system according to (1) or (2), wherein the processing circuitry is configured to, responsive to an input to the specialized operator graphical user interface, change one or more of the tasks within the SIC window or add one or more ‘Available’ tasks for the SIC window.

(4) The assignment engine system according to any one of (1) to (3), wherein the processing circuitry assigns the haul trucks to the selected tasks so as to finish as many of the selected tasks as possible in order of the task ranking taking into consideration at least one additional selected task within the SIC window.

(5) The assignment engine system according to any one of (1) to (4), wherein the SIC window is three hours in duration, and wherein the tasks are production tasks.

(6) The assignment engine system according to any one of (1) to (5), wherein a production rate of one or more of the haul trucks having been assigned one or more of the tasks is set to vary over the SIC window.

(7) The assignment engine system according to any one of (1) to (6), further comprising: the plurality of the haul trucks to perform loading, hauling, and unloading operations at the mine site; the one or more loaders to perform loading of the plurality of haul trucks at the mine site; and a central station in wireless electronic communication with the plurality of haul trucks and the one or more loaders, wherein the electronically received data includes real-time mine site-related data and real-time machine-related data.

(8) A computer-implemented method of managing a mine site comprising: electronically importing a short-term plan as a set of one or more immutable jobs into memory of a processor; electronically creating, using the processor, ranked tasks from and for the one or more immutable jobs to be performed by work machines at the mine site; selectively transitioning, using the processor, at least some of the tasks from a first state to a second state; electronically identifying, using the processor, a short interval control (SIC) window associated with the short-term plan, the SIC window being shorter in time than the short-term plan; determining which of the tasks are in the second state and overlap the SIC window in time; automatically electronically assigning the work machines to the tasks determined to be in the second state and overlapping the SIC window; and electronically outputting, on a specialized operator graphical user interface, the assignments of the work machines to the tasks overlapping the SIC window, wherein a production rate of one or more of the work machines is set to vary over the SIC window when performing the one or more tasks.

(9) The computer-implemented method according to (8), wherein said selectively transitioning is indirect from the first state to the second state, the second state being an ‘Available’ state.

(10) The computer-implemented method according to (8) or (9), further comprising: electronically receiving, using the processor, data associated with the mine site, the data including mine site-related data and machine-related data regarding work machines for the mine site; and controlling the work machines at the mine site to perform the tasks based on the assignments of the work machines responsive to output signaling from the processor indicating the assignments of the work machines to the tasks, wherein the electronically received data includes real-time mine site-related data and real-time machine-related data, and wherein said electronically creating the ranked tasks is performed based on the mine site-related data and the machine-related data.

(11) The computer-implemented method according to any one of (8) to (10), further comprising, responsive to an input to the specialized operator graphical user interface, adding one or more new tasks for said selectively transitioning.

(12) The computer-implemented method according to any one of (8) to (11), wherein said assigning the work machines to the tasks is such that the work machines perform the tasks so as to finish as many of the tasks as possible in order of task ranking within a predefined time, and wherein the work machines are at least one of a plurality of hauling trucks, a plurality of watering machines, a plurality of grading machines, a plurality of dozers, and a plurality of wheel loaders.

(13) The computer-implemented method according to any one of (8) to (12), wherein the SIC window is three hours in duration.

(14) The computer-implemented method according to any one of (8) to (13), wherein the work machines include a plurality of haul trucks and a loading machine, and wherein said assigning the work machines includes allocation of the plurality of haul trucks to the loading machine.

(15) A non-transitory computer-readable storage medium having stored thereon instructions that, when executed by one or more processors, causes the one or more processors to perform a method comprising: automatically creating, from and for immutable jobs of an imported short-term plan, ranked production tasks to be performed by a plurality of haul trucks at a mine site; identifying a short interval control (SIC) window associated with the short-term plan, the SIC window being shorter in time than the short-term plan; determining which of the production tasks identified as being in a predefined state, from among multiple predefined states, overlap the SIC window in time; selecting, from among all of the production tasks in the predefined state, only the production tasks that overlap the SIC window; automatically assigning each of the selected production tasks to the haul trucks based on task ranking and taking into account each of the other selected production tasks within the SIC window; and outputting, on a specialized operator graphical user interface, interactive visual representations of the assignments of the haul trucks to the production tasks.

(16) The non-transitory computer-readable storage medium according to (15), wherein the selected production tasks are assigned to the haul trucks such that the haul trucks are scheduled to finish as many of the production tasks as possible by a predetermined time.

(17) The non-transitory computer-readable storage medium according to (15) or (16), wherein the selected production tasks are assigned to the haul trucks such that a production rate of one or more of the haul trucks is scheduled to vary.

(18) The non-transitory computer-readable storage medium according to any one of (15) to (17), wherein said assigning the production tasks to the haul trucks includes assigning one or more loading machines to the production tasks.

(19) The non-transitory computer-readable storage medium according to any one of (15) to (18), wherein the method further comprises selectively transitioning, using the specialized operator graphical user interface, the production tasks to the predefined state.

(20) The non-transitory computer-readable storage medium according to any one of (15) to (19), wherein the method further comprises modifying one or more of the production tasks.

As will be appreciated by one skilled in the art, aspects of the present disclosure may be embodied as a system, method or computer program product. Accordingly, aspects of the present disclosure may take the form of an entirely hardware embodiment, an entirely software embodiment, including firmware, resident software, or micro-code, as examples, or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Further, as used herein, the term “circuitry” can refer to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present. This definition of “circuitry” can apply to all uses of this term in this application, including in any claims. As a further example, as used in this application, the term “circuitry” can also cover an implementation of merely a processor (or multiple processors) or portion of a processor and its (or their) accompanying software and/or firmware.

Use of the terms “data,” “content,” “information” and similar terms may be used interchangeably, according to some example embodiments of the present disclosure, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Aspects of the present disclosure have been described above with reference to flowchart illustrations and/or block diagrams of methods, apparatus (systems) and computer program products according to embodiments of the present disclosure. In this regard, the flowchart and block diagrams in the Figures illustrate the architecture, functionality, and operation of possible implementations of systems, methods and computer program products according to various embodiments of the present disclosure. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the present disclosure to any particular orientation or configuration. Furthermore, terms such as “first,” “second,” “third,” etc., merely identify one of a number of portions, components, points of reference, operations and/or functions as described herein, and likewise do not necessarily limit embodiments of the present disclosure to any particular configuration or orientation.

While aspects of the present disclosure have been particularly shown and described with reference to the embodiments above, it will be understood by those skilled in the art that various additional embodiments may be contemplated by the modification of the disclosed machines, assemblies, systems, and methods without departing from the spirit and scope of what is disclosed. Such embodiments should be understood to fall within the scope of the present disclosure as determined based upon the claims and any equivalents thereof.

1. An assignment engine system to perform managing operations according to task-based short-term planning comprising:
planning circuitry configured to electronically provide a short-term plan for a mine site to be managed, the short-term plan defining at least an amount of material to be moved at the mine site; and
processing circuitry operative as a fleet management system (FMS) and configured to
electronically import, from the planning circuitry, the short-term plan as a set of immutable jobs into memory of the processing circuitry,
electronically receive data associated with the mine site, the data including mine site-related data and machine-related data regarding a plurality of haul trucks and one or more loaders for the mine site,
electronically automatically create ranked tasks from and for the immutable jobs to be performed by at least the haul trucks based on the mine-site related data and the machine-related data,
selectively transition, using a specialized operator graphical user interface in coordination with the processing circuitry, the tasks from a ‘Ready’ state to an ‘Available’ state,
electronically identify a short interval control (SIC) window associated with the short-term plan, the SIC window being shorter in time than the short-term plan,
determine which of the tasks in the ‘Available’ state overlap the SIC window in time,
electronically select, from among all of the tasks in the ‘Available’ state, only the tasks in the ‘Available’ state that overlap the SIC window in time,
automatically electronically assign the haul trucks to the selected tasks over the SIC window based on the task ranking and such that as many of the selected tasks are to be finished as possible in order of the task ranking within a predefined time period, and
electronically output, on the specialized operator graphical user interface, indicia showing the assignment of the haul trucks to the selected tasks over the SIC window.

2. The assignment engine system according to claim 1, wherein the processing circuitry outputs signaling to provide instructions and/or commands to the haul trucks and the one or more loaders to perform the assigned tasks according to the task ranking.

3. The assignment engine system according to claim 1, wherein the processing circuitry is configured to, responsive to an input to the specialized operator graphical user interface, change one or more of the tasks within the SIC window or add one or more ‘Available’ tasks for the SIC window.

4. The assignment engine system according to claim 1, wherein the processing circuitry assigns the haul trucks to the selected tasks so as to finish as many of the selected tasks as possible in order of the task ranking taking into consideration at least one additional selected task within the SIC window.

5. The assignment engine system according to claim 1,
wherein the SIC window is three hours in duration, and
wherein the tasks are production tasks.

6. The assignment engine system according to claim 1, wherein a production rate of one or more of the haul trucks having been assigned one or more of the tasks is set to vary over the SIC window.

7. The assignment engine system according to claim 1, further comprising:
the plurality of the haul trucks to perform loading, hauling, and unloading operations at the mine site;
the one or more loaders to perform loading of the plurality of haul trucks at the mine site; and
a central station in wireless electronic communication with the plurality of haul trucks and the one or more loaders,
wherein the electronically received data includes real-time mine site-related data and real-time machine-related data.

8. A computer-implemented method of managing a mine site comprising:
electronically importing a short-term plan as a set of one or more immutable jobs into memory of a processor;
electronically creating, using the processor, ranked tasks from and for the one or more immutable jobs to be performed by work machines at the mine site;
selectively transitioning, using the processor, at least some of the tasks from a first state to a second state;
electronically identifying, using the processor, a short interval control (SIC) window associated with the short-term plan, the SIC window being shorter in time than the short-term plan;
determining which of the tasks are in the second state and overlap the SIC window in time;
automatically electronically assigning the work machines to the tasks determined to be in the second state and overlapping the SIC window; and
electronically outputting, on a specialized operator graphical user interface, the assignments of the work machines to the tasks overlapping the SIC window,
wherein a production rate of one or more of the work machines is set to vary over the SIC window when performing the one or more tasks.

9. The computer-implemented method according to claim 8, wherein said selectively transitioning is indirect from the first state to the second state, the second state being an ‘Available’ state.

10. The computer-implemented method according to claim 8, further comprising:
electronically receiving, using the processor, data associated with the mine site, the data including mine site-related data and machine-related data regarding work machines for the mine site; and
controlling the work machines at the mine site to perform the tasks based on the assignments of the work machines responsive to output signaling from the processor indicating the assignments of the work machines to the tasks,
wherein the electronically received data includes real-time mine site-related data and real-time machine-related data, and
wherein said electronically creating the ranked tasks is performed based on the mine site-related data and the machine-related data.

11. The computer-implemented method according to claim 8, further comprising, responsive to an input to the specialized operator graphical user interface, adding one or more new tasks for said selectively transitioning.

12. The computer-implemented method according to claim 8,
wherein said assigning the work machines to the tasks is such that the work machines perform the tasks so as to finish as many of the tasks as possible in order of task ranking within a predefined time, and
wherein the work machines are at least one of a plurality of hauling trucks, a plurality of watering machines, a plurality of grading machines, a plurality of dozers, and a plurality of wheel loaders.

13. The computer-implemented method according to claim 8, wherein the SIC window is three hours in duration.

14. The computer-implemented method according to claim 8,
wherein the work machines include a plurality of haul trucks and a loading machine, and
wherein said assigning the work machines includes allocation of the plurality of haul trucks to the loading machine.

15. A non-transitory computer-readable storage medium having stored thereon instructions that, when executed by one or more processors, causes the one or more processors to perform a method comprising:
automatically creating, from and for immutable jobs of an imported short-term plan, ranked production tasks to be performed by a plurality of haul trucks at a mine site;
identifying a short interval control (SIC) window associated with the short-term plan, the SIC window being shorter in time than the short-term plan;
determining which of the production tasks identified as being in a predefined state, from among multiple predefined states, overlap the SIC window in time;
selecting, from among all of the production tasks in the predefined state, only the production tasks that overlap the SIC window;
automatically assigning each of the selected production tasks to the haul trucks based on task ranking and taking into account each of the other selected production tasks within the SIC window; and
outputting, on a specialized operator graphical user interface, interactive visual representations of the assignments of the haul trucks to the production tasks.

16. The non-transitory computer-readable storage medium according to claim 15, wherein the selected production tasks are assigned to the haul trucks such that the haul trucks are scheduled to finish as many of the production tasks as possible by a predetermined time.

17. The non-transitory computer-readable storage medium according to claim 15, wherein the selected production tasks are assigned to the haul trucks such that a production rate of one or more of the haul trucks is scheduled to vary.

18. The non-transitory computer-readable storage medium according to claim 15, wherein said assigning the production tasks to the haul trucks includes assigning one or more loading machines to the production tasks.

19. The non-transitory computer-readable storage medium according to claim 15, wherein the method further comprises selectively transitioning, using the specialized operator graphical user interface, the production tasks to the predefined state.

20. The non-transitory computer-readable storage medium according to claim 15, wherein the method further comprises modifying one or more of the production tasks.
